(19) United States
(12) Patent Application Publication
(10) Pub. No.: US 2016/0019266 A1
(43) Pub. Date: Jan. 21, 2016

(54) QUERY GENERATING METHOD AND QUERY GENERATING DEVICE

(71) Applicant: HITACHI, LTD., Chiyoda-ku, Tokyo (JP)

(72) Inventors: Satoshi KATSUNUMA, Tokyo (JP); Tsuneyuki IMAKI, Tokyo (JP); Shinichi KAWAMOTO, Tokyo (JP); Tsunehiko BABA, Tokyo (JP)

(73) Assignee: Hitachi, Ltd., Chiyoda-ku, Tokyo (JP)

(21) Appl. No.: 14/771,338

(22) PCT Filed: Dec. 25, 2013
(86) PCT No.: PCT/JP2013/084690

§ 371 Date: Aug. 28, 2015

(51) Int. Cl. G06F 17/30

(52) U.S. Cl. CPC G06F 17/30516; G06F 17/30389; G06F 17/3056; G06F 17/30864

(57) ABSTRACT

Provided is a query generating method for generating a query which processes an inputted data stream with a computer provided with a processor and memory, said method comprising: a first step of the computer separating the inputted data stream into a required column and an optional column, and loading a template which defines a process with respect to the required column; and a second step of the computer separating the inputted data stream into a required column and an optional column, processing the required columns with the template, and generating a query which outputs the result of the processing of the template and the optional column as one instance of data.

### BACKGROUND

This invention relates to a technology of creating a template for a query for processing stream data.

Stream data processing is known as a technology of processing data from a multitude of sensors, and data related to settlement and buying and selling of financial organizations or other similar entities. In stream data processing, a query is registered in a system first and, when data arrives, the query is executed continuously. Continuous Query Language (CQL) is a favorable example of a language in which the query is written.

There has been known a technology of creating a template for a stream data processing query that is written in CQL in order to expand the range of use of stream data processing (for example, US 2011/0093490 A1).

### SUMMARY

In the technology of US 2011/0093490 A1, however, the schema of input stream data that is defined in the template is fixed. The schema of the template therefore needs to be modified depending on the type of the data source when a large quantity of information as in a social networking service (SNS), a blog, or the like is used for input stream data. Specifically, the schema of a template that has information of one SNS as input stream data differs from a schema for information of other SNSs and, accordingly, it is necessary to redefine the template in the language in which the query is written, or to prepare numerous templates in advance.

Redefining a template in the language in which the query is written requires a person capable of programming a query, and not all users who use stream data processing possess that ability. Preparing numerous templates in advance has a problem of increasing the work and cost of software engineers and the like.

This invention has been made in view of the problems described above, and an object of this invention is therefore to cut the cost of developing a template for a query by receiving a plurality of inputs without preparing numerous templates.

A representative aspect of this invention is as follows. A query generating method for generating a query for processing input stream data, the query generating method being performed by a computer comprising a processor and a memory, the query generating method comprising: a first step of reading, by the computer, a template in which the input stream data is divided into an essential column and an option column, and processing to be executed for the essential column is defined; and a second step of generating, by the computer, a query for dividing the input stream data into the essential column and the option column, for processing the essential column by using the template, and for outputting a result of the processing of the template and the option column as one piece of data.

According to this invention, input stream data is divided into an essential column and an option column, and the essential column on which processing of a template has been performed is combined with the option column. Receiving inputs of a plurality of types with the use of a single template is thus accomplished, and the cost of developing a template can be reduced by keeping the number of template types small.

### BRIEF DESCRIPTION OF THE DRAWINGS

FIG. 1 is a block diagram for illustrating an example of a computer system according to a first embodiment of this invention.

FIG. 2 is a block diagram for illustrating an outline of processing that is executed by each stream processing query generated with the use of the templates according to the first embodiment of this invention.

FIG. 3 is a block diagram for illustrating an example of input-output relations of the query generating module according to the first embodiment of this invention.

FIG. 4A is a diagram for showing an example of a template according to the first embodiment of this invention.

FIG. 4B is a diagram for showing another example of a template according to the first embodiment of this invention.

FIG. 5A is a diagram for showing an example of template configuration information according to the first embodiment of this invention.

FIG. 5B is a diagram for showing another example of template configuration information according to the first embodiment of this invention.

FIG. 6 is a diagram for showing an example of the stream processing definitions according to the first embodiment of this invention.

FIG. 7 is a diagram for showing an example of the template calling information according to the first embodiment of this invention.

FIG. 8 is the first half of a diagram for showing an example of one stream processing query that is generated by the query generating module with the use of the templates according to the first embodiment of this invention.

FIG. 9 is the second half of a diagram for showing an example of one stream processing query that is generated by the query generating module with the use of the templates according to the first embodiment of this invention.

FIG. 10 is a flowchart for illustrating an example of processing that is executed by the template calling information generating module according to the first embodiment of this invention.

FIG. 11 is a flowchart for illustrating an example of processing that is executed by the combining processing inserting module according to the first embodiment of this invention.

FIG. 12 is a flowchart for illustrating an example of processing that is executed in the ID assigning query definition generating processing according to the first embodiment of this invention.

FIG. 13 is a flowchart for illustrating an example of processing that is executed in the in-template query definition generating processing according to the first embodiment of this invention.

FIG. 14 is a flowchart for illustrating an example of processing that is executed in the combining query definition generating processing according to the first embodiment of this invention.

FIG. 15 is a block diagram for illustrating an example of input-output relations of a template registering module according to a second embodiment of this invention.

FIG. 16 is a diagram for showing an example of the ID-unassigned template according to the second embodiment of this invention.

FIG. 17 is a diagram for showing an example of the ID-assigned template according to the second embodiment of this invention.

FIG. 18 is a diagram for illustrating an example of the operator tree of the ID-unassigned template according to the second embodiment of this invention.

FIG. 19 is a diagram for showing an example of the partial template configuration information according to the second embodiment of this invention.

FIG. 20 is a diagram for showing an example of template configuration information according to the second embodiment of this invention.

FIG. 21 is a flowchart for illustrating an example of processing that is executed by the template registering module according to the second embodiment of this invention.

FIG. 22 is a flowchart for illustrating an example of processing that is executed by the automatic ID assigning module according to the second embodiment of this invention.

FIG. 23 is a flowchart for illustrating an example of processing that is executed by the window size calculating module according to the second embodiment of this invention.

FIG. 24 is a block diagram for illustrating an example of input-output relations of the query generating module according to the second embodiment of this invention.

FIG. 25 is the first half of a diagram for showing an example of the stream processing query according to a third embodiment of this invention.

FIG. 26 is the second half of the diagram for showing an example of the stream processing query according to the third embodiment of this invention.

FIG. 27 is a flowchart for illustrating an example of processing that is executed by the option column inserting module of the query generating module according to the third embodiment of this invention.

FIG. 28A is a diagram for showing an example of the template according to a fourth embodiment of this invention.

FIG. 28B is a diagram for showing an example of the template according to the fourth embodiment of this invention.

FIG. 29A is a diagram for showing an example of template configuration information according to the fourth embodiment of this invention.

FIG. 29B is a diagram for showing an example of template configuration information according to the fourth embodiment of this invention.

FIG. 30 is a diagram for showing an example of the stream processing definitions according to the fourth embodiment of this invention.

FIG. 31 is a diagram for showing an example of the template calling information generated by the query generating module according to the fourth embodiment of this invention.

FIG. 32 is the first half of a diagram for showing an example of the stream processing query according to the fourth embodiment of this invention.

FIG. 33 is the second half of a diagram for showing an example of the stream processing query according to the fourth embodiment of this invention.

### DETAILED DESCRIPTION OF THE PREFERRED EMBODIMENTS

Embodiments of this invention are described below with reference to the accompanying drawings.

### First Embodiment

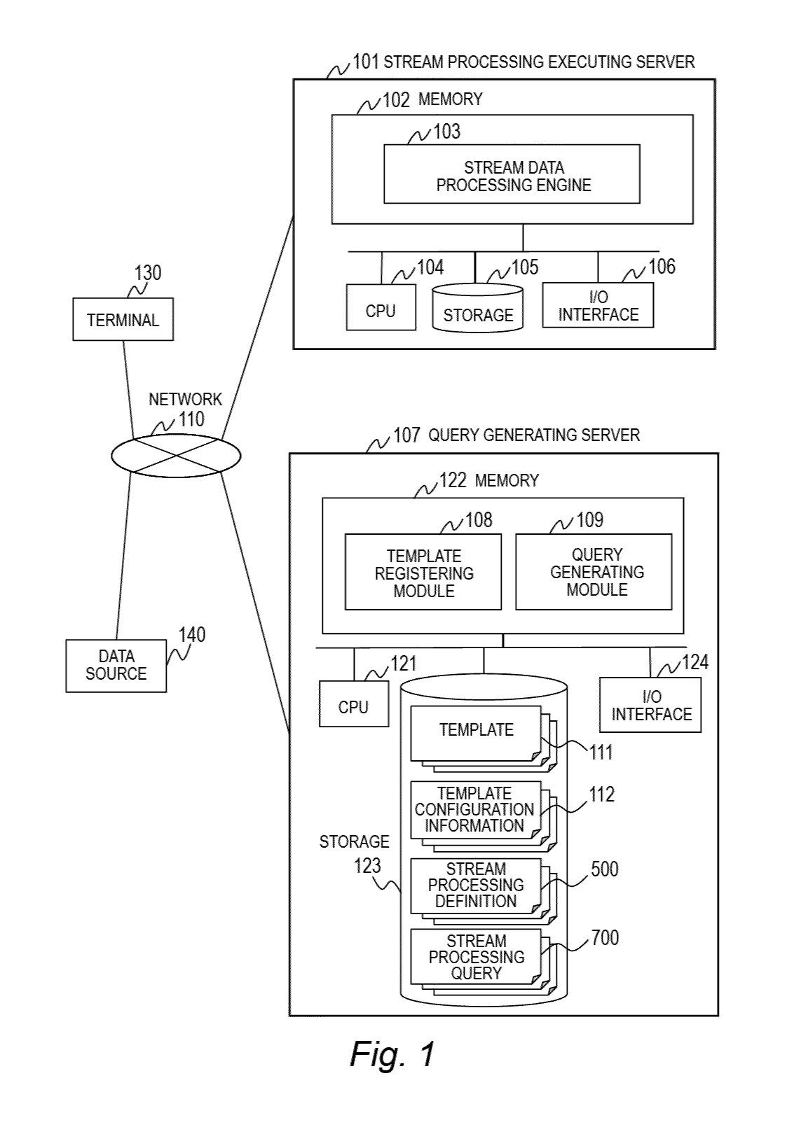

FIG. 1 is a block diagram for illustrating an example of a computer system according to a first embodiment of this invention. A stream processing executing server 101, which executes processing of stream data, is coupled via a network 110 to a query generating server 107, which generates stream processing queries 700 based on a template, a terminal 130 through which a template is operated and other types of operation is performed, and a data source 140, which supplies stream data. The data source 140 can be, for example, a social networking service (SNS) or a blog.

The stream processing executing server 101 includes a CPU 104, which executes computing processing, a memory 102, which holds data and programs, storage 105, which stores programs and data, and an I/O interface 106, which is coupled to the network 110. A stream data processing engine 103 in the form of a program is loaded onto the memory 102 and executed by the CPU 104. The stream data processing engine 103 can be stored in the storage 105.

The stream data processing engine 103 processes stream data received from the data source 140 by, as described later, continuously executing the relevant stream processing query 700 generated by the query generating server 107. Continuous Query Language (CQL) described above, for example, can be used for the stream processing queries 700. The following description takes as an example a case in which the stream processing queries 700 are written in CQL.

The query generating server 107 includes a CPU 121, which executes computing processing, a memory 122, which holds data and programs, storage 123, which stores programs and data, and an I/O interface 124, which is coupled to the network 110. A template registering module 108 and a query generating module 109 in the form of a program are loaded onto the memory 122 and executed by the CPU 121. The storage 123 stores templates 111, pieces of template configuration information 112, stream processing definitions 500, and the stream processing queries 700. The template registering module 108 and the query generating module 109 in the form of a program can be stored in the storage 123.

The template configuration information 112 and function modules of the query generating module 109 are loaded in the form of a program onto the memory 122. The CPU 121 executes processing as programmed by the respective programs of the function modules, to thereby operate as function modules that provide given functions. For example, the CPU 121 executes processing as programmed by a template registering program, to thereby function as the template registering module 108. The same applies to other programs. The CPU 121 further operates as function modules that provide functions of a plurality of processing procedures executed by each program. A computer and a computer system are an apparatus and a system that include those function modules.

Programs, tables, and other types of information for implementing the functions of the query generating server 107 can be stored in the storage 123, or in a non-volatile semiconductor memory, or in a storage device such as a hard disk drive or a solid state drive (SSD), or in a computer-readable, non-transitory data storage medium such as an IC card, an SD card, or a DVD.

In main processing of the query generating server 107, the template registering module 108 sets the templates 111 and stores the templates 111 and the template configuration information 112 in the storage 123. When a stream processing definition is input, the templates 111 and the template configuration information 112 are used by the query generating module 109 to generate the stream processing queries 700.

The terminal 130 is a computer that includes a CPU, a memory, storage, an I/O interface, and an input/output apparatus (not shown), and is operated by a user or an administrator.

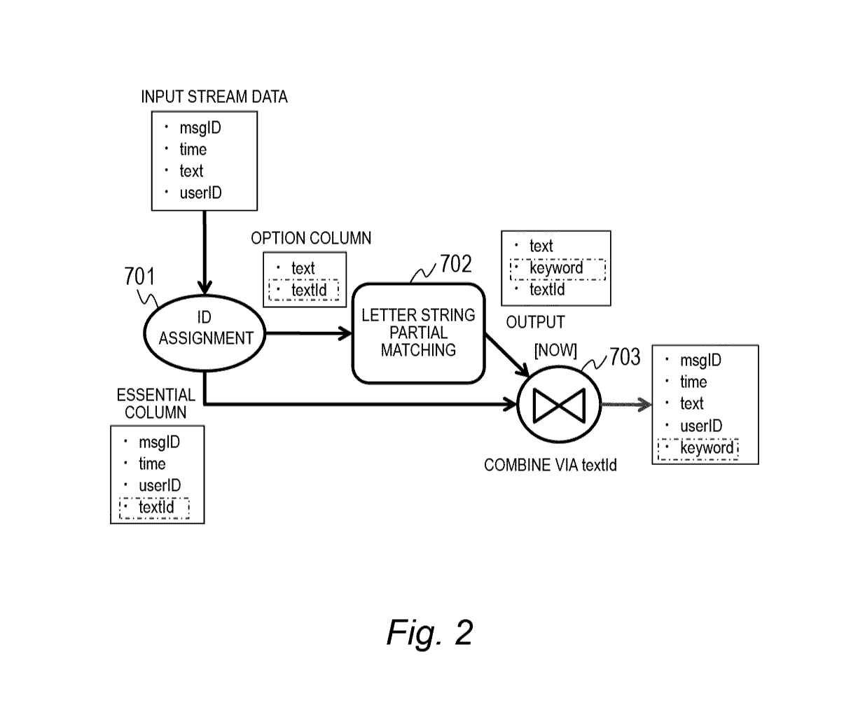

FIG. 2 is a block diagram for illustrating an outline of processing that is executed by each stream processing query 700 generated with the use of the templates 111 of this invention.

The stream processing query 700 divides input stream data into two types of data by extracting an essential column, which includes text, from the stream data and extracting an option column from the stream data. The stream processing query 700 at this point assigns an identifier that associates the essential column and the option column with each other (701). In the example of FIG. 2, the stream processing query 700 assigns a text ID (“textID” in the drawing) to each of the essential column and the option column.

The stream processing query 700 then executes template processing to check whether the essential column partially matches a letter string that is a given keyword (“keyword”), and outputs the essential column that includes the given keyword (702). The stream processing query 700 uses a given window operator to combine the output of the letter string partial matching processing with option column data whose text ID matches the text ID of the output (703). In the example of FIG. 2, the NOW window is used to combine the output stream data of the template processing (702) with the option column data.

In this invention, an essential column, which includes essential text, is extracted from input stream data and other portions of the input stream data than the text of the essential column is separated as an option column. The essential column is processed by given processing (702) with the use of one of the templates 111, and the output of the template 111 is then combined with the option column.

In this manner, only the essential column needs to be defined in each template 111 in order to apply the template 111 to stream data that has a different schema. In addition, the option column can be handled as metadata. The option column may be input stream data itself, or may be data that is obtained by subtracting the essential column from input stream data.

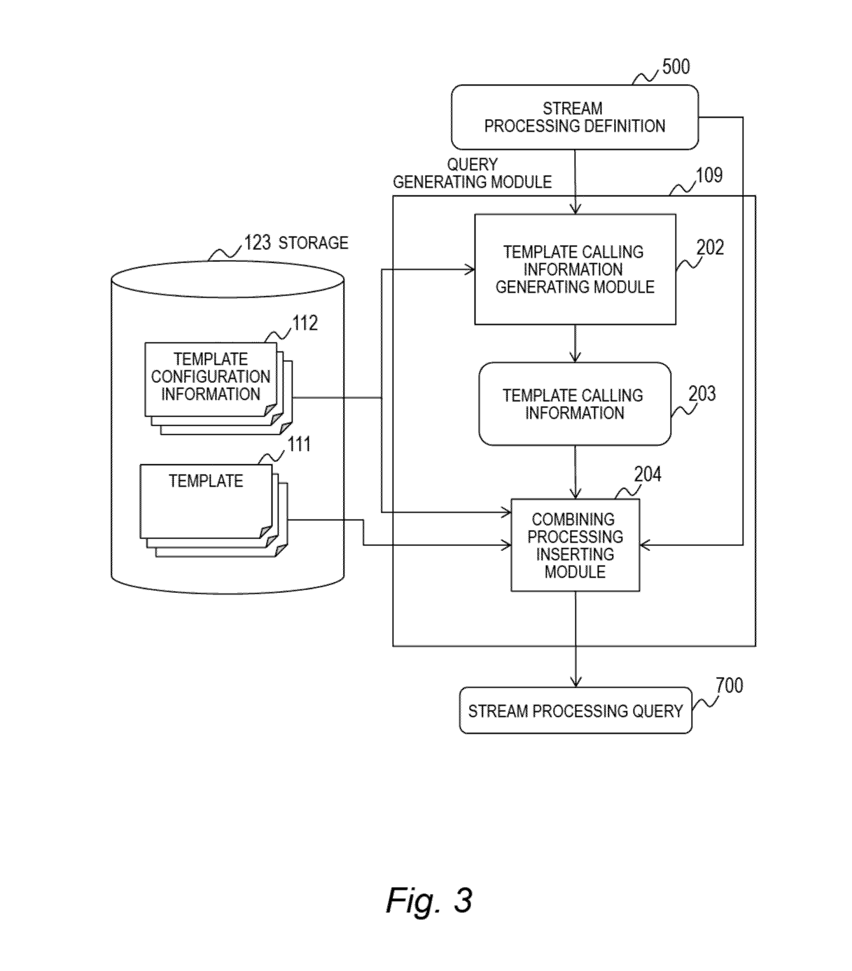

FIG. 3 is a block diagram for illustrating an example of input-output relations of the query generating module 109. The query generating module 109 includes a template calling information generating module 202 to which the preset stream processing definitions 500 are input to generate template calling information 203, and a combining processing inserting module 204, which generates the stream processing query 700.

The template calling information generating module 202 obtains configuration information of the templates 111 (the template configuration information 112) written in the stream processing definitions 500, and generates the template calling information 203, which indicates for each template 111 the relation between input stream data and output stream data.

The combining processing inserting module 204 generates the stream processing query 700 by determining the output column to be combined and the window size based on the stream processing definitions 500 and the template configuration information 112.

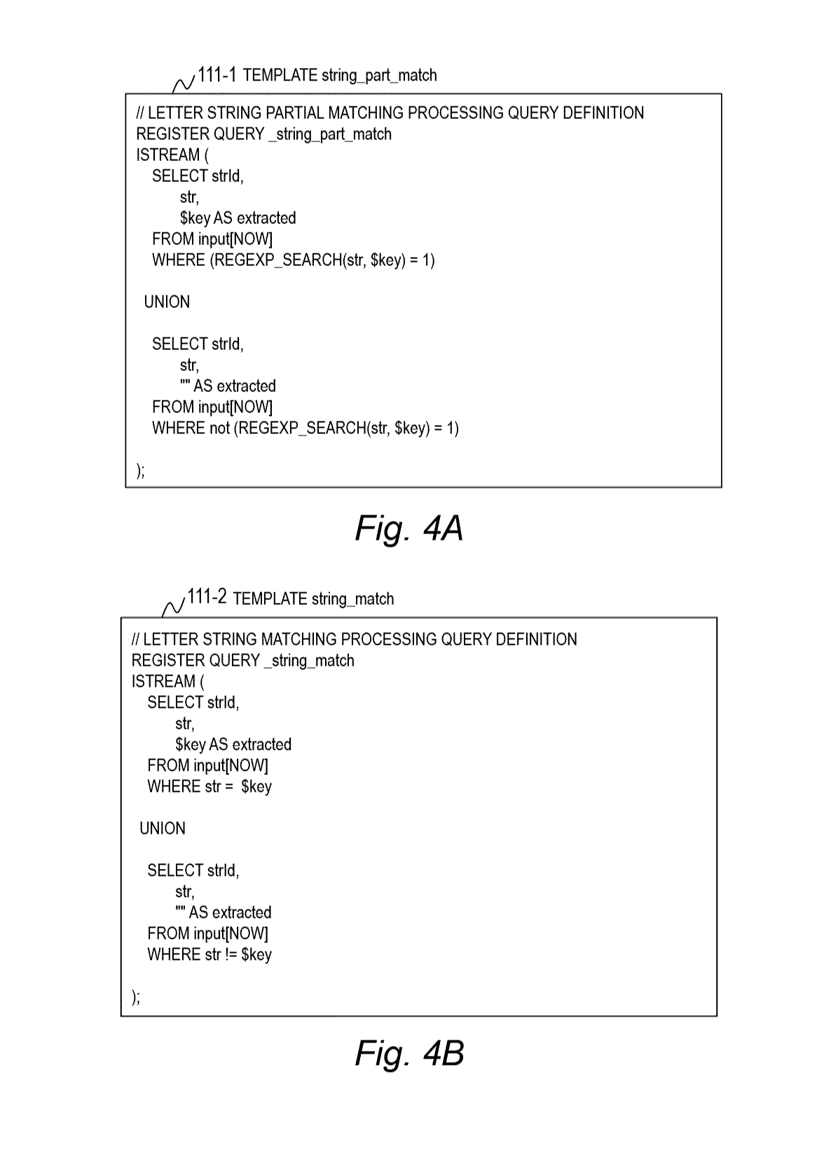

An example of the templates 111 used in this embodiment is shown in FIG. 4A and FIG. 4B. FIG. 4A is a diagram for showing an example of a template 111-1 (string_part_match).

The template 111-1 defines a query that combines inquiry results of two SELECT statements. The query defined by the template 111-1 combines an inquiry in which, when the value of an essential column “str” includes a letter string specified by “$key”, the value of “extracted” is the letter string specified by “$key” with an inquiry in which, when the value of the essential column “str” does not include the letter string specified by “$key”, the value of “extracted” is an empty letter string.

FIG. 4B is a diagram for showing an example of a template 111-2 (string_match).

The template 111-2 defines a query that combines inquiry results of two SELECT statements. The query defined by the template 111-2 combines an inquiry in which, when the value of the essential column “str” matches the letter string specified by “$key”, the value of “extracted” is the letter string specified by “$key” with an inquiry in which, when the value of the essential column “str” does not match the letter string specified by “$key”, the value of “extracted” is an empty letter string.

The templates 111-1 and 111-2 are collectively denoted by a symbol 111 in the following description.

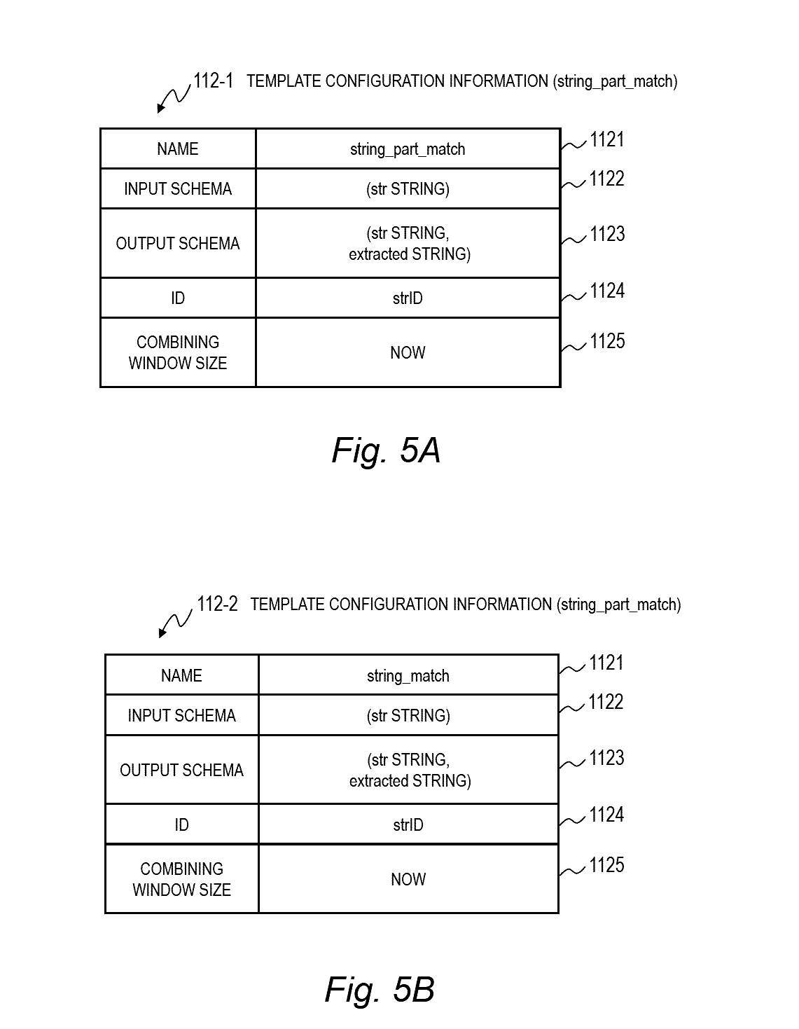

FIG. 5A is a diagram for showing an example of template configuration information 112-1 (string_part_match). The template configuration information 112-1 stores configuration information of the template 111-1 of FIG. 4A which is “string_part_match”.

The template configuration information 112-1 includes a field for a name 1121 in which the name (or function name) of the template 111-1 is stored, a field for an input schema 1122, which corresponds to the essential column, a field for an output schema 1123, which indicates an output from the template 111-1, a field for an ID 1124 in which an identifier is stored, and a field for a combining window size 1125 in which the window size in combining processing is stored.

The input schema 1122 corresponds to an essential column 2034 of the template calling information 203 which is described later, and the output schema 1123 corresponds to an output column 2036 of the template calling information 203.

FIG. 5B is a diagram for showing an example of template configuration information 112-2 (string_match). The template configuration information 112-2 stores configuration information of the template 111-2 of FIG. 4B, which is “string_match”. The template configuration information 112-2 has fields for a name 1121 to a combining window size 1125 in which values are stored the same way as in the template configuration information 112-1 described above.

The template configuration information 112-1 and 112-2 are collectively denoted by a symbol 112 in the following description.

As described, the templates 111 and template configuration information 112 of this invention define only a letter string (STRING) as the essential column of the input schema 1122, which allows the system to handle data of various SNSs and a diversity of blogs as input stream data.

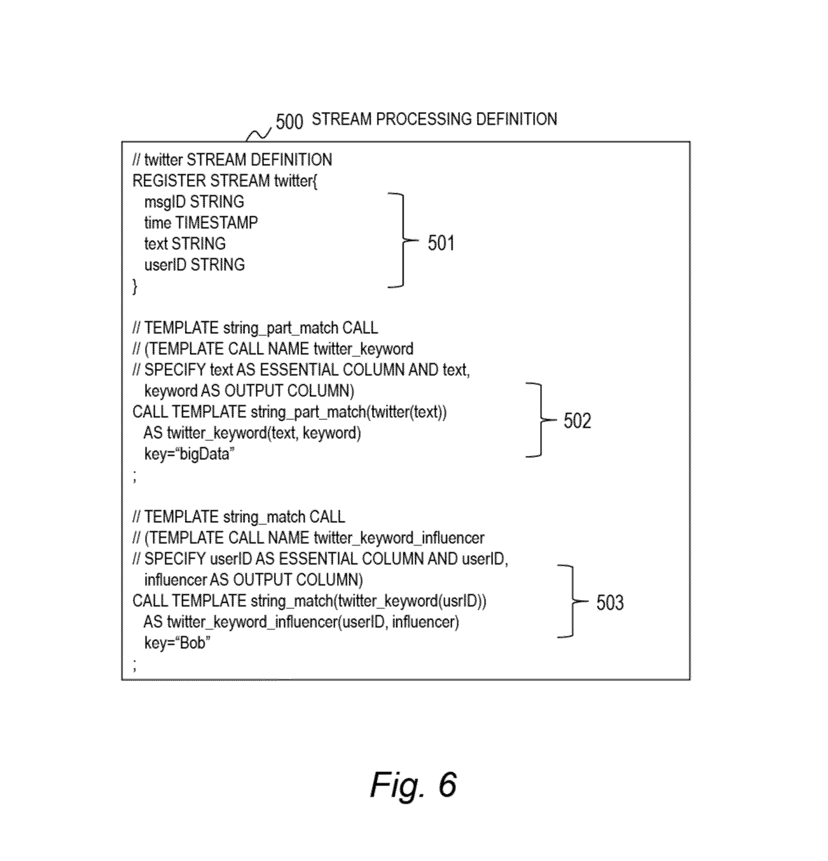

FIG. 6 is a diagram for showing an example of the stream processing definitions 500. The stream processing definitions 500 are created in advance by a developer or the like and stored in the storage 123. The query generating server 107 follows one of the stream processing definitions 500 that is specified by a query generation request from the terminal 130 in generating one stream processing query 700.

Each stream processing definition 500 defines the name and configuration of stream data that is input in a stream definition 501. In the example of FIG. 6, the name of input stream data is “twitter”, a “msgID” column holds a letter string, a “time” column holds a time stamp, a “text” column holds a letter string, and a “userID” column holds a letter string. Those constitute the input schema of input stream data the name of which is “twitter”.

The stream processing definition 500 further defines that two templates 111 are to be called in template calls 502 and 503. The template call 502 indicates that a template whose call name is “twitter_keyword” and whose type (or function) is “string_part_match” (letter string partial matching processing) is called in “CALL TEMPLATE”. The template call 502 indicates that, in the template having the call name “twitter_keyword” (111-1 of FIG. 4A), a column “text” of stream data “twitter” is the essential column, columns “text” and “keyword” of stream data “twitter_keyword” are output stream data, and a variable “key” is “bigData”.

In the template call 503, the template (111-2 of FIG. 4B) whose call name is “twitter_keyword_influencer” and whose type (or function) is “string_match” (letter string matching processing) is called in “CALL TEMPLATE”. The template call 503 indicates that, in the template 111-2 having the call name “twitter_keyword_influence”, a column “userID” of stream data “twitter_keyword” is the essential column, columns “userID” and “influencer” of stream data “twitter_keyword_influencer” are output stream data, and a variable “key” is “Bob”. Input stream data of the template having the call name “twitter_keyword_influencer” is the output stream data of the template “twitter_keyword” of the template call 502.

The option column of the template having the call name “twitter_keyword” includes other columns than the essential column “text” out of the columns in the stream definition 501, namely, the columns “msgID”, “time”, and “userID”. The option column of the template having the call name “twitter_keyword_influencer” includes other columns than the essential column “userID”, namely, the columns “msgID”, “time”, “text”, and “keyword”. The columns “msgID”, “time”, “text”, and “userID” constitute the input schema of the template having the call name “twitter_keyword_influencer”.

The stream processing definitions 500 thus define for each template 111 stream data that is input and stream data that is output.

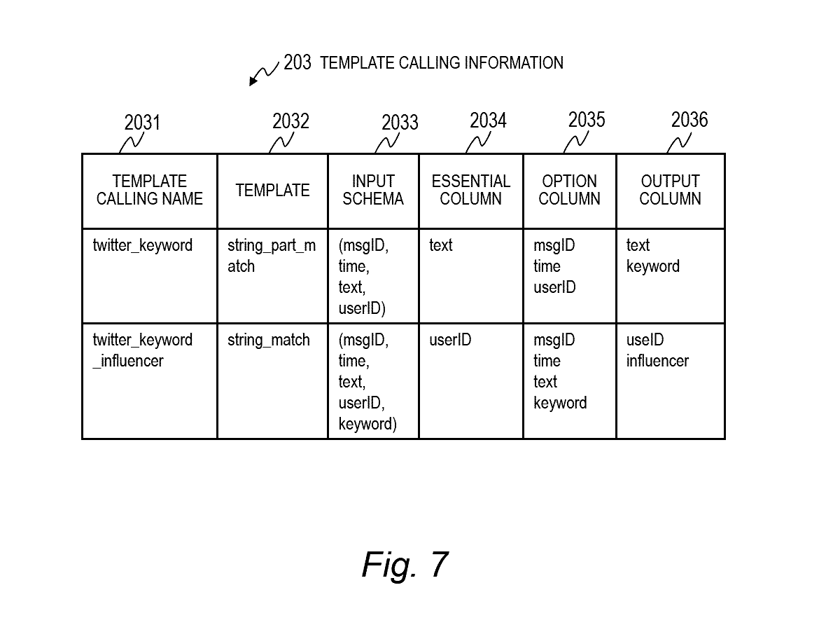

FIG. 7 is a diagram for showing an example of the template calling information 203. The template calling information 203 is a table that holds input-output relations extracted from the stream processing definition 500 of FIG. 6.

Each single record of the template calling information 203 includes a field for a template call name 2031 which stores the call name of one of the templates 111 in the stream processing definition 500 of FIG. 6, a field for a template 2032 which stores the type (or function) of the template 111, a field for an input schema 2033 which stores columns to be input, a field for an essential column 2034 which stores the essential column of the template 111, a field for an option column 2035, and a field for an output column 2036 which stores columns output from the template 111.

The values of those fields 2031 to 2036 may be extracted from the stream definition 501 and definitions of the template calls 502 and 503 of FIG. 6.

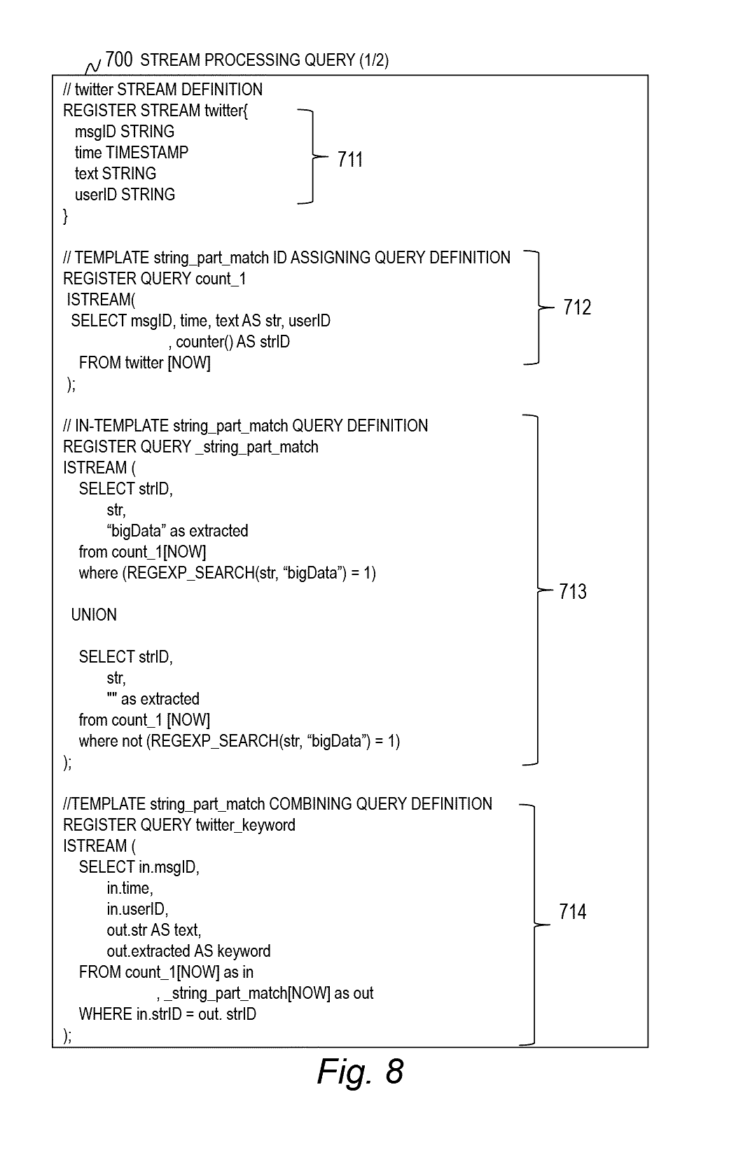

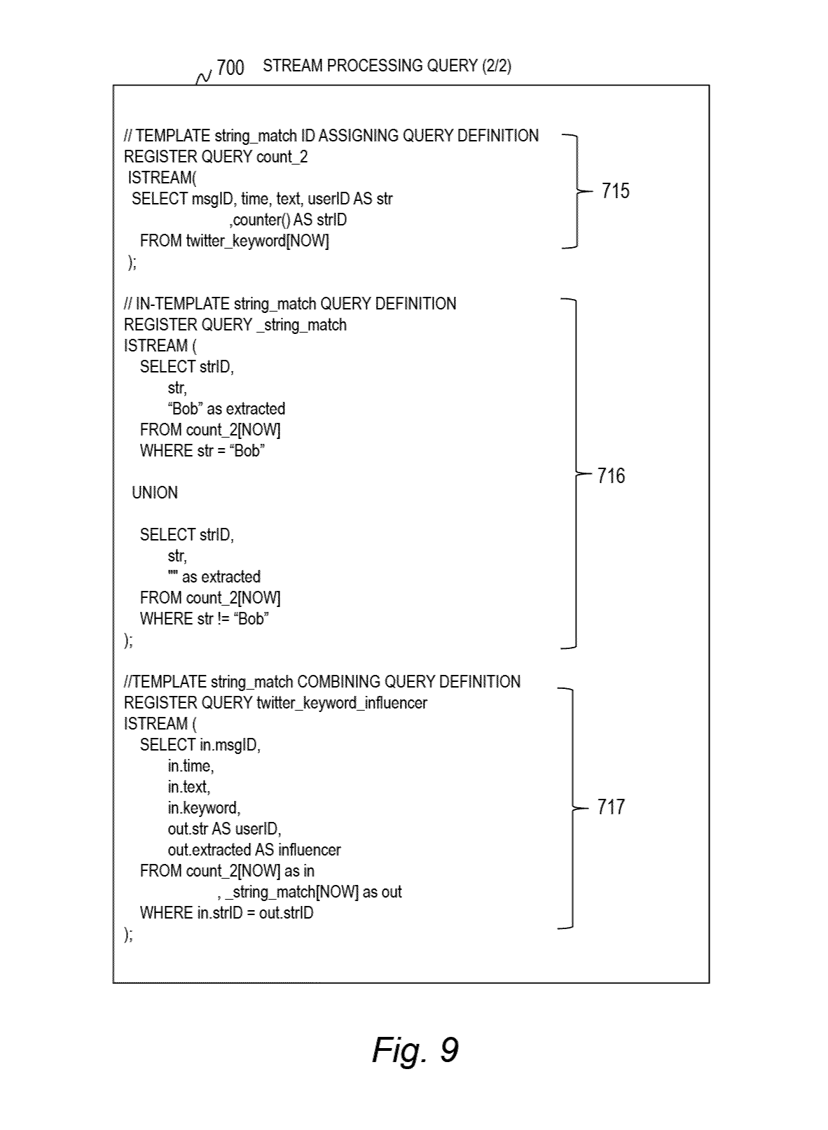

FIG. 8 and FIG. 9 are the first half and second half of a diagram for showing an example of one stream processing query 700 that is generated by the query generating module 109 with the use of the templates 111. The query generating module 109 creates in 711 of FIG. 8 a definition that is a copy of the stream definition 501 in the stream processing definition 500 of FIG. 6, and that defines the name and input schema of stream data processing.

The query generating module 109 defines in 712 of FIG. 8 a query that assigns an ID to the input data and that associates the essential column and the option column with each other. This query corresponds to the ID assignment of FIG. 2.

The query generating module 109 next reads the template call 502 of the read stream processing definition 500 and the template 111-1 to deploy the specifics of “string_part_match” of the template 111-1 in the stream processing query 700 (713). The query generating module 109 inserts a combining query definition that combines the output column of the template “string_part_match” with the option column (714). The insertion of the combining query definition is executed by the combining processing inserting module 204 of FIG. 3 in a manner described later.

In 715 to 717 of FIG. 9, the query generating module 109 executes steps similar to those in FIG. 8 which include assigning an ID to data (715), reading the template call 503 of the read stream processing definition 500 and the template 111-2 to deploy the specifics of “string_match” of the template 111-2 in the stream processing query 700 (716), and inserting a combining query definition that combines the output column of the template “string_match” with the option column (717). The insertion of the combining query definition is executed, as in 714 described above, by the combining processing inserting module 204 in a manner described later.

The query generating module 109 thus generates the stream processing query 700 from the two templates 111-1 and 111-2 that are included in the read stream processing definition 500.

Details of the processing that is executed by the query generating module 109 of FIG. 3 are described below.

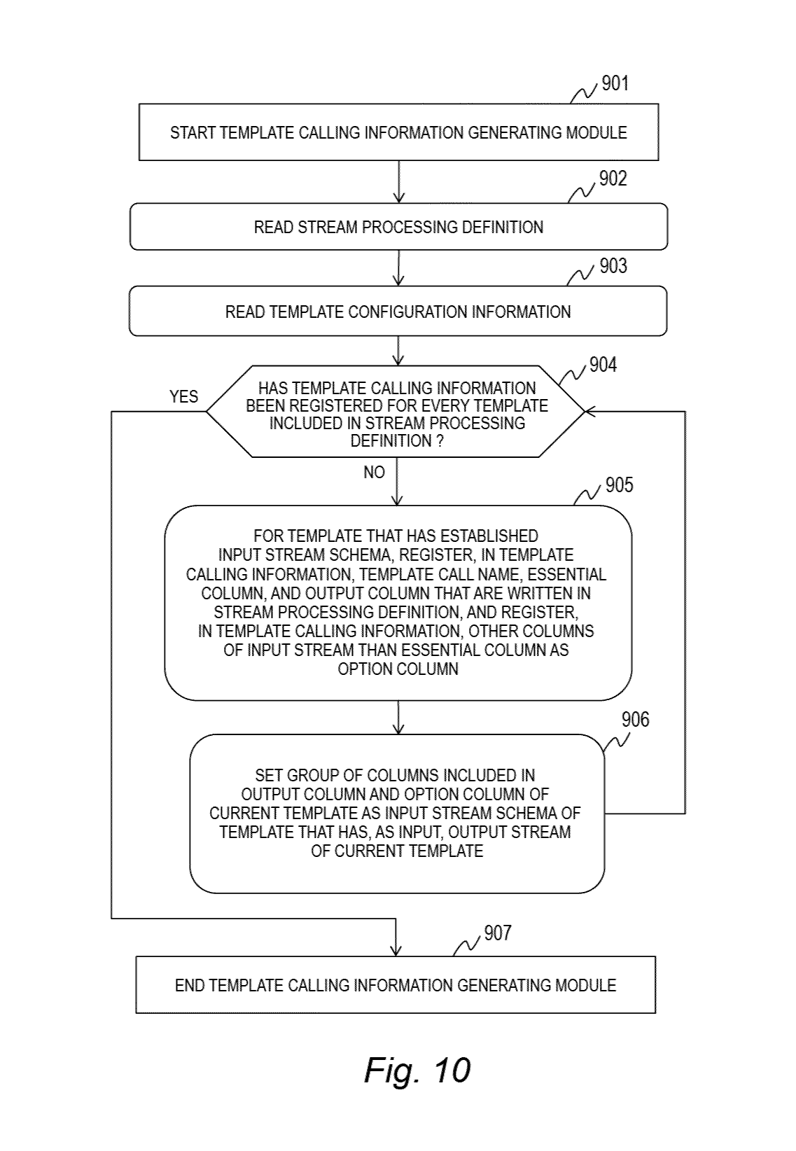

FIG. 10 is a flowchart for illustrating an example of processing that is executed by the template calling information generating module 202. This processing is executed when the query generating server 107 receives a query generation request from the terminal 130 (901). The query generation request specifies one of the stream processing definitions 500.

The template calling information generating module 202 of the query generating module 109 reads the stream processing definitions 500 specified in the query generation request out of the storage 123 (902). The template calling information generating module 202 next extracts the templates 111 that are included in the stream processing definitions 500. The template calling information generating module 202 reads configuration information of the extracted templates 111 (the template configuration information 112) out of the storage 123 (903). The templates 111 extracted from the stream processing definitions 500 may be the templates 111 that are written in “CALL TEMPLATE” as in the template calls 502 and 503 of FIG. 6.

The template calling information generating module 202 determines for each read piece of the template configuration information 112 whether or not the template calling information 203 is registered in the memory 122 (904).

In the case where the template calling information 203 is already registered for every read piece of the template configuration information 112, the template calling information generating module 202 ends the processing (907).

In the case where the template configuration information 112 for which the template calling information 203 has not been registered is found, the template calling information generating module 202 generates the template calling information 203 for each found piece of the template configuration information 112, and stores the generated information in the memory 122 in Steps 905 and 906.

First, in Step 905, the template calling information generating module 202 obtains from the stream processing definitions 500 information about a template for which the schema of input stream data has been established. With the schema of input stream data established, input schemata and output schemata are tracked starting from the template 111 that has the stream definition 501 in the stream processing definitions 500 of FIG. 6 as an input to register the template calling information 203 for each piece of the template configuration information 112. Specifically, a template call name, an input schema, an essential column, and an output column that are written in the stream processing definitions 500 are registered as 2031, 2033, 2034, and 2036, respectively, in the template calling information 203. The template calling information generating module 202 also registers other columns of the input stream data than the essential column (which can be obtained from the input schema 2033) as the option column 2035 in the template calling information 203.

In Step 906, the template calling information generating module 202 sets the group of columns included in the output column 2036 and the option column 2035 as the schema of input stream data of the next template, which has the output stream data of the current template 111 as an input. In other words, the output schema of the preceding template 111 is established and the template 111 that has the established output schema as an input is set as the next processing target. The template calling information generating module 202 then returns to Step 904 to repeat the processing described above for every read piece of the template configuration information 112.

Through the processing described above, the template calling information 203 is generated for the template configuration information 112 of each template written in the stream processing definitions 500 while establishing input schemata and output schemata. In other words, the processing is executed sequentially from the template 111 for which the output schema of its preceding template has been established. The template calling information 203 may be stored in the storage 123.

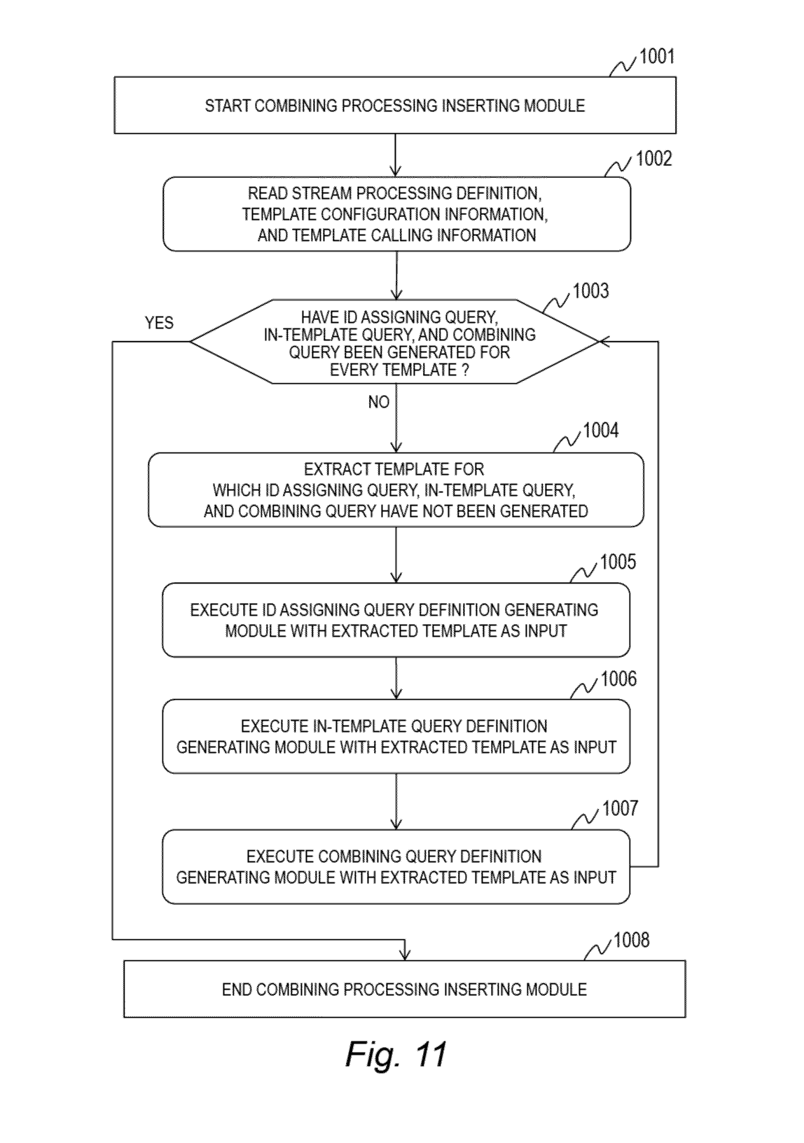

FIG. 11 is a flowchart for illustrating an example of processing that is executed by the combining processing inserting module 204 of the query generating module 109 of FIG. 3. This processing is executed after the processing of the template calling information generating module 202 is completed.

The combining processing inserting module 204 first reads the stream processing definitions 500, the template configuration information 112, and the template calling information 203 (1001 and 1002). The combining processing inserting module 204 determines whether or not the generation of the ID assigning query, the in-template query, and the combining query has been completed for every template 111 written in the stream processing definitions 500 (1003). In the case where the generation processing has been completed for every written template 111, the combining processing inserting module 204 ends this combining processing (1008). In the case where the template 111 for which the generation processing has not been completed is found, the combining processing inserting module 204 repeatedly executes Steps 1004 to 1006 until every written template 111 has been processed.

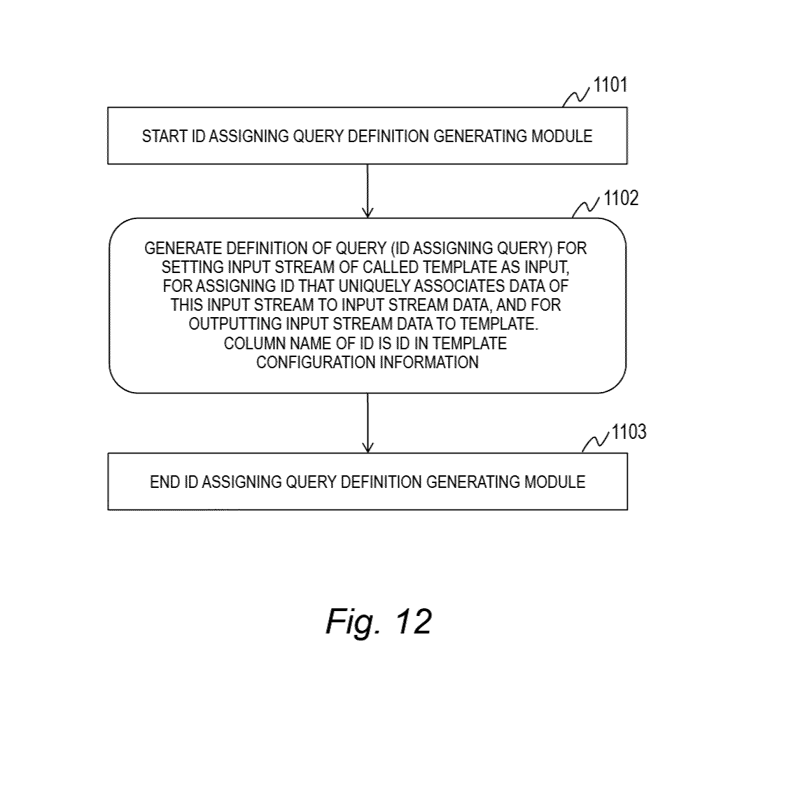

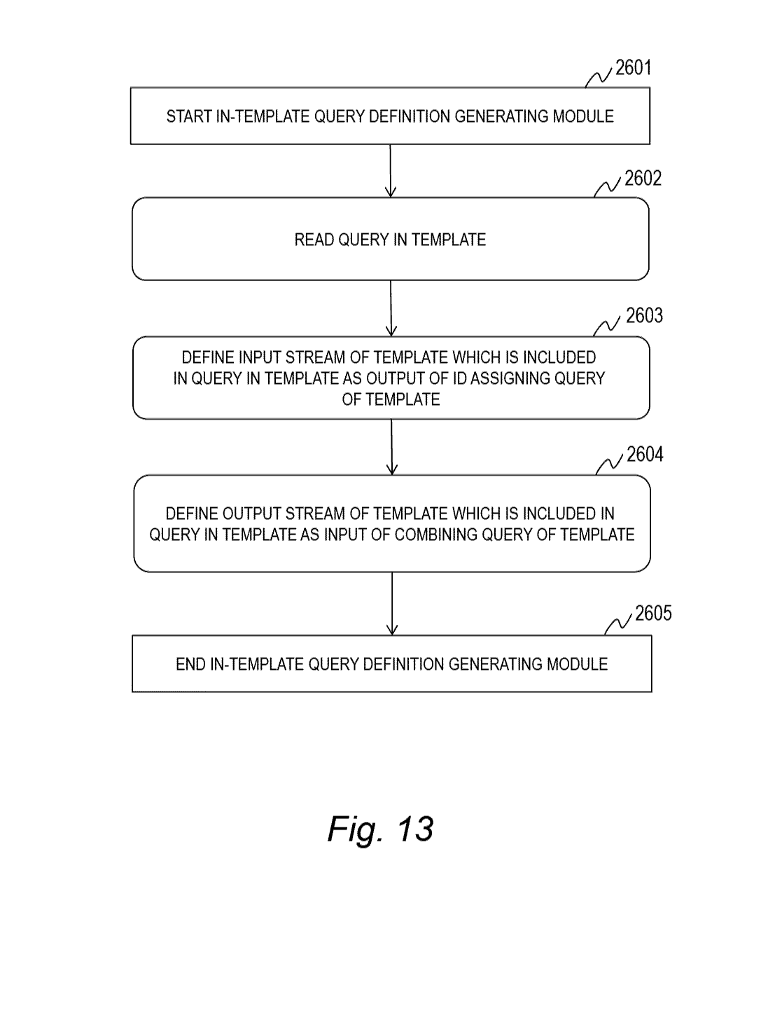

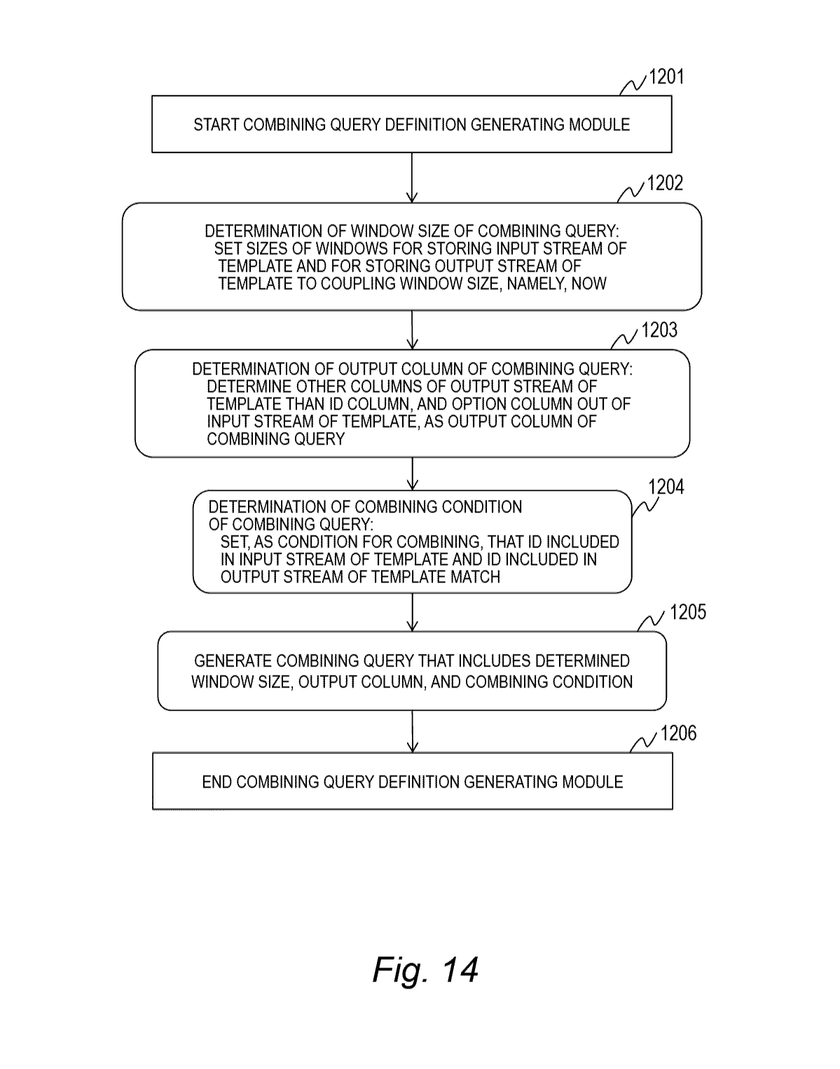

The combining processing inserting module 204 extracts the template 111 for which the ID assigning query, the in-template query, and the combining query have not been generated (1004). The combining processing inserting module 204 executes ID assigning query definition generating processing (an ID assigning query definition generating module) shown in FIG. 12 for the extracted template 111 (1005). The combining processing inserting module 204 next executes in-template query definition generating processing (an in-template query definition generating module) shown in FIG. 13 (1006). The combining processing inserting module 204 then executes combining query definition generating processing (a combining query definition generating module) shown in FIG. 14 (1007).

Details of processing of generating the ID assigning query, the in-template query, and the combining query for each template 111 are described below. The combining processing inserting module 204 includes the ID assigning query definition generating module, the in-template query definition generating module, and the combining query definition generating module, and is at the center of the execution of the following processing.

FIG. 12 is a flowchart for illustrating an example of processing that is executed in the ID assigning query definition generating processing of Step 1005 in FIG. 11. The combining processing inserting module 204 calls one template 111 out of the extracted templates 111, and sets, as an input, input stream data that is input to the called template 111 (1101 and 1102).

The combining processing inserting module 204 generates the definition of a query for assigning the input stream data an identifier that uniquely associates the input stream data with the output of the template 111 (for example, textID of FIG. 2) (the ID assigning query). The column name of the identifier is the ID in the template configuration information 112 (1124 of FIG. 5A).

Through the processing described above, the combining processing inserting module 204 generates a query for assigning the input stream data an identifier that uniquely associates the input stream data with the output of the template 111 as the ID assigning query definition of the called template 111. The ID assigning query definitions in 712 of FIGS. 8 and 715 of FIG. 9 are generated by this processing in this embodiment.

FIG. 13 is a flowchart for illustrating an example of processing that is executed in the in-template query definition generating processing of Step 1006 in FIG. 11. The combining processing inserting module 204 executes the following processing for the template 111 called in FIG. 12 (2601).

The combining processing inserting module 204 reads a query written in the called template 111 (2602). The combining processing inserting module 204 defines input stream data of the called template 111 which is included in the read query as the output of the ID assigning query generated in FIG. 12 (2603). The combining processing inserting module 204 defines output stream data of the called template 111 which is included in the read query as an input of the combining query, which is described later (2604).

The combining processing inserting module 204 generates the definition of the in-template query through the processing described above, and then ends the processing (2605). The query definitions in 713 of FIGS. 8 and 716 of FIG. 9 are generated by this processing in this embodiment.

FIG. 14 is a flowchart for illustrating an example of processing that is executed in the combining query definition generating processing of Step 1007 in FIG. 11. The combining processing inserting module 204 executes the following processing for the template 111 called in FIG. 12 (1201).

The combining processing inserting module 204 determines the window size of the combining query. The NOW window is set as the window size for the combining of the template 111 with output stream data of the template 111. The window for data that is simply input stream data to which an ID has been assigned (the option column) as illustrated in FIG. 2 is set to one minute, and the combining query is defined so that output stream data on which given processing has been performed is combined by using the NOW window (1202).

The combining processing inserting module 204 determines the output column of the combining query. The combining processing inserting module 204 determines, as the output column of the combining query, other columns of the output stream data of the template 111 than the ID column and the option column out of input stream data of the template 111 (1203). Columns to be combined as illustrated in FIG. 2 are thus set out of the columns of the output stream data and the option column.

The combining processing inserting module 204 next determines a combining condition of the combining query. For example, such a combining condition is determined that an ID assigned to input stream data (option column) of the template 111 (strID=textID) matches an ID included in output stream data of the template 111 (strID=textID) as illustrated in Step 703 of FIG. 2.

The combining processing inserting module 204 uses the determined window size, output column, and combining condition to determine a SELECT statement, a FROM statement, and a WHERE statement, and thus generates the combining query (1205).

Through the processing described above, the definition of the combining query for combining input stream data and output stream data of the template 111 is generated, and the processing is ended (1206). The query definitions in 714 of FIGS. 8 and 717 of FIG. 9 are generated by this processing in this embodiment.

By executing the processing described above of FIG. 12 to FIG. 14 for one template 111, the ID assigning query, the in-template query, and the combining query are generated and are stored as one stream processing query 700 in the storage 123 of the query generating server 107.

The terminal 130 transmits a stream processing request in which one of the stream processing queries 700 is specified to the stream processing executing server 101. The stream processing executing server 101 obtains the specified stream processing query 700 from the query generating server 107, and executes the stream processing query 700 with the use of the stream data processing engine 103. The stream processing executing server 101 receives stream data from the data source 140 and uses the stream processing query 700 to execute given processing.

In this invention, where each template 111 and template configuration information 112 define only a letter string (STRING) as the essential column of the input schema 1122 as shown in FIG. 4A and FIG. 4B and FIG. 5A and FIG. 5B, text data of SNSs and various blogs can be handled as input stream data, which makes the template 111 applicable irrespective of the SNS type (or provider) or the blog type (or provider) unlike the related art.

A single template 111 can thus receive a plurality of inputs, instead of preparing numerous templates, and the cost of developing a template for a query is accordingly reduced.

In addition, when text data of a new service is used, the existing template 111 can be applied instead of creating a new template 111. This enables a user with a low program developing ability to use stream data easily. Second Embodiment

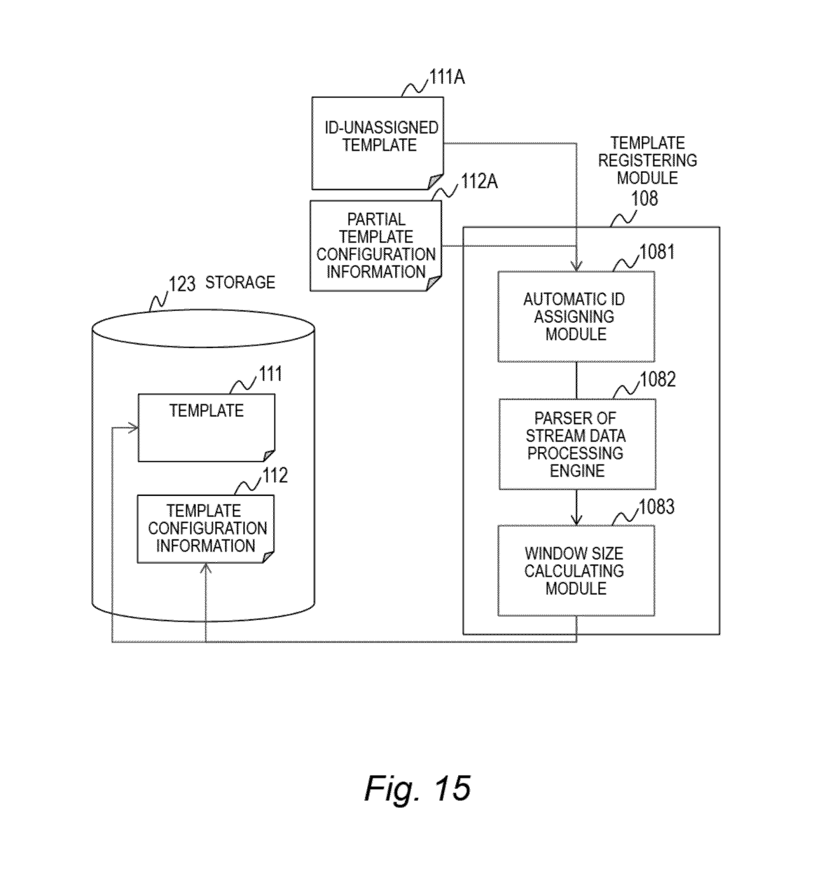

FIG. 15 is a block diagram for illustrating an example of input-output relations of a template registering module 108 according to a second embodiment of this invention. This embodiment describes an example of automatically executing ID assignment and window size determination by using as an input an ID-unassigned template 111A to which an ID (strID) and a window size in combining have not been assigned, and partial template configuration information 112A. The query generating server 107 starts processing of the ID-unassigned template 111A and the partial template configuration information 112A when a registration request is received from the terminal 130. The window size here refers to the window size (“NOW” of 703) of output stream data to be combined with the option column of FIG. 2.

The template registering module 108 of the second embodiment receives as an input the ID-unassigned template 111A and the partial template configuration information 112A in which the ID and the window size are undetermined, and generates the template 111 and the template configuration information 112, which include an ID (strID) and a window size as in the first embodiment, in a manner described later.

For that purpose, the template registering module 108 has an automatic ID assigning module 1081, a parser (parsing module) 1082 of the stream data processing engine 103 of the stream processing executing server 101, and a window size calculating module 1083 as shown in FIG. 15. The rest of the configuration is the same as in the first embodiment. The parser 1082 is registered in the template registering module 108 in advance from the stream data processing engine 103 of the stream processing executing server 101.

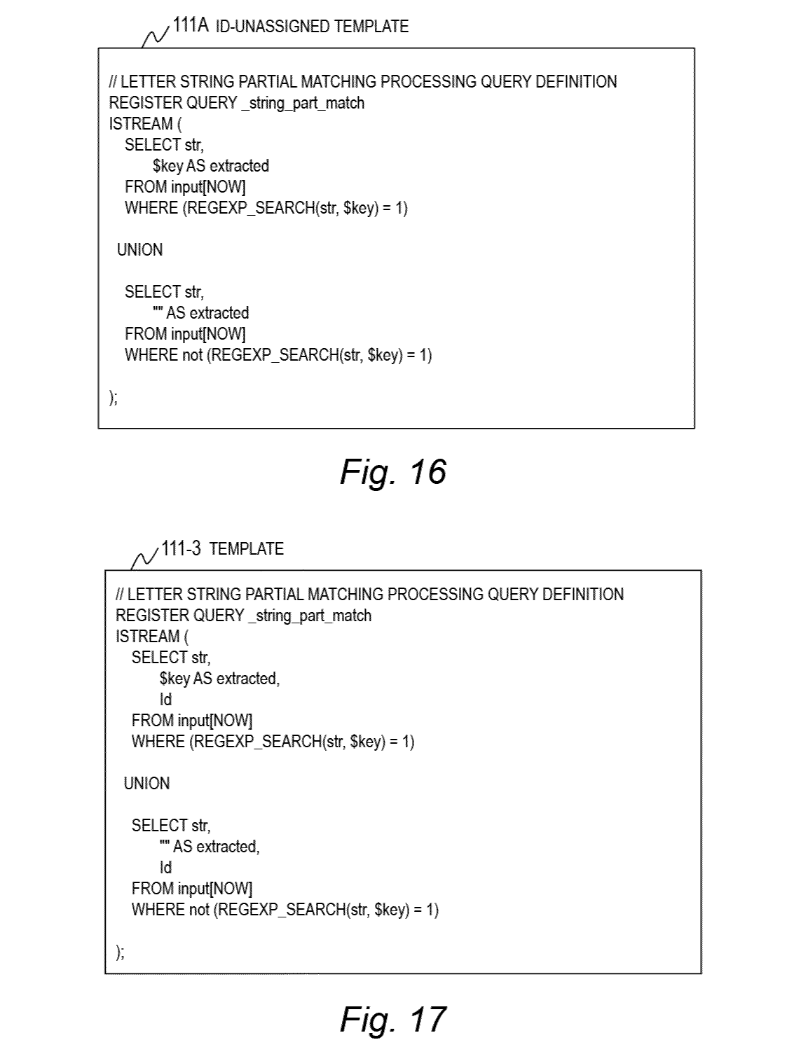

FIG. 16 is a diagram for showing an example of the ID-unassigned template 111A. In the template 111A, only “str” and “$key” are defined in SELECT statements, and an ID (strID) as the one described in the first embodiment with reference to FIG. 4A is not defined. FIG. 17, on the other hand, is a diagram for showing an example of a template 111-3 to which an ID has been assigned by the automatic ID assigning module 1081.

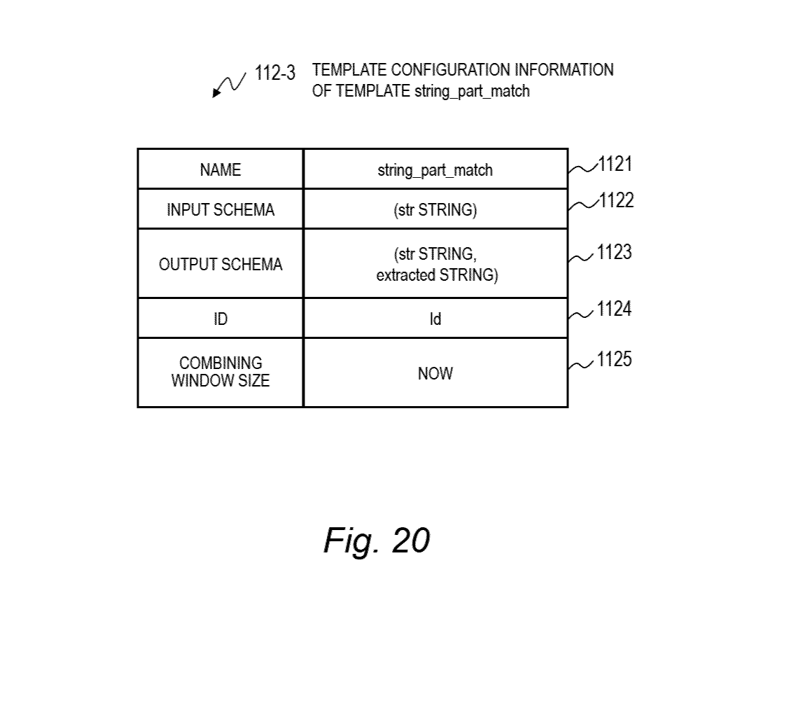

FIG. 19 is a diagram for showing an example of the partial template configuration information 112A. In the partial template configuration information 112A, the name 1121, the input schema 1122, and the output schema 1123 are defined, but the ID 1124 and the window size 1125 are not defined. FIG. 20, on the other hand, is a diagram for showing an example of template configuration information 112-3 to which an ID has been assigned by the automatic ID assigning module 1081.

The automatic ID assigning module 1081 of the template registering module 108 of FIG. 15 reads the ID-unassigned template 111A and the partial template configuration information 112A and, when assigning an ID is possible, adds the definition of a query for assigning an ID to generate the template 111-3 and the template configuration information 112-3.

For example, “id” is not defined in the SELECT statements in the ID-unassigned template 111A of FIG. 16. The automatic ID assigning module 1081 of the template registering module 108 processes the ID-unassigned template 111A to generate the template 111-3 in which “id” is inserted in each of the two SELECT statements as shown in FIG. 17.

When assigning an ID to the template 111A is possible, the automatic ID assigning module 1081 of the template registering module 108 also assigns “id” as the ID 1124 in the partial template configuration information 112A, in a manner described later. The window size 1125 is set to “NOW” by the window size calculating module 1083 of the template registering module 108 when the template 111-3 (111A) fulfills a given condition, thereby generating the template configuration information 112-3.

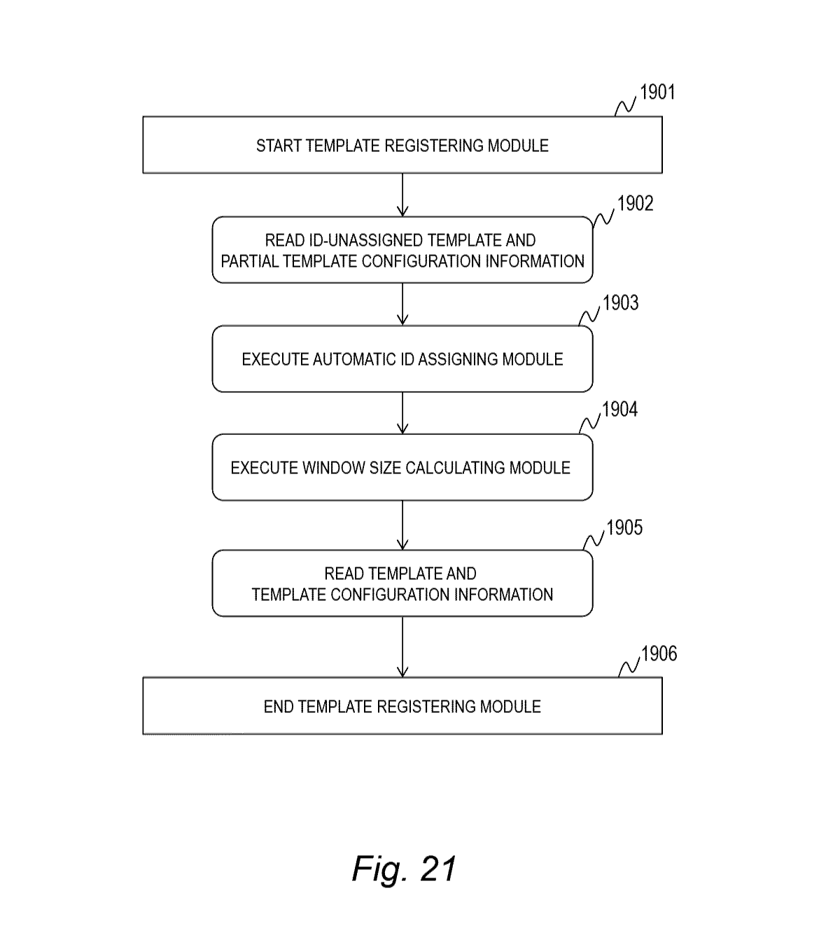

FIG. 21 is a flowchart for illustrating an example of processing that is executed by the template registering module 108. The template registering module 108 starts the processing when receiving the ID-unassigned template 111A and the partial template configuration information 112A (1901). The template registering module 108 reads the received ID-unassigned template 111A and partial template configuration information 112A (1902).

The automatic ID assigning module 1081 of the template registering module 108 analyzes the read ID-unassigned template 111A to determine whether or not an ID can be assigned as described later. When assigning an ID is possible, the automatic ID assigning module 1081 assigns an ID to the ID-unassigned template 111A and the partial template configuration information 112A (1903). When assigning an ID is not possible, the automatic ID assigning module 1081 notifies the terminal 130 of the fact that no ID can be assigned.

The window size calculating module 1083 of the template registering module 108 analyzes the read ID-unassigned template 111A to determine a window size that is used when the option column and the output stream data are combined (1904). In the case where determining the window size is not possible, the window size calculating module 1083 notifies the terminal 130 of the fact that the window size cannot be determined.

The template registering module 108 stores in the storage 123 the template 111-3 to which an ID has been assigned and the template configuration information 112-3 in which an ID and a window size have been set (1905).

Through the processing described above, the ID-unassigned template 111A and the partial template configuration information 112A are received and, when the ID-unassigned template 111A fulfills a given condition, the template 111-3 and the template configuration information 112-3 are generated and stored in the storage 123 (1906).

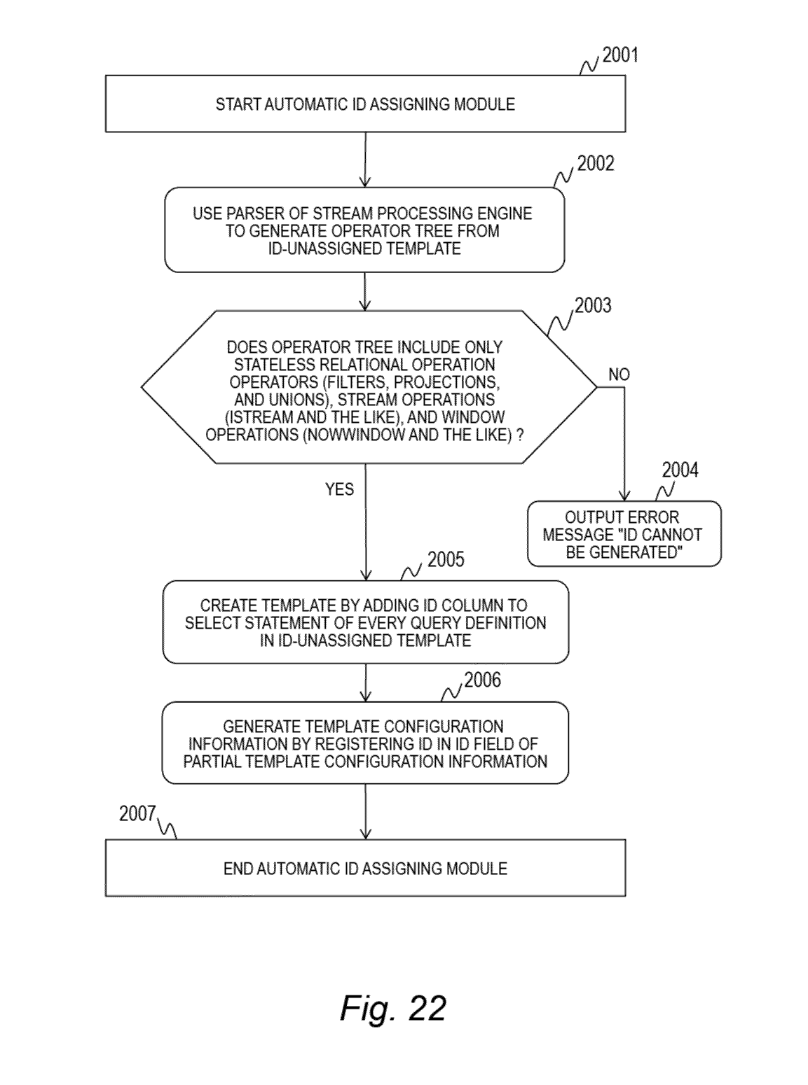

FIG. 22 is a flowchart for illustrating an example of processing that is executed by the automatic ID assigning module 1081. This processing is the one that is executed in Step 1903 of FIG. 21 (2001).

The automatic ID assigning module 1081 uses the parser 1082 of the stream data processing engine 103 to parse the ID-unassigned template 111A, and generates an operator tree (2002).

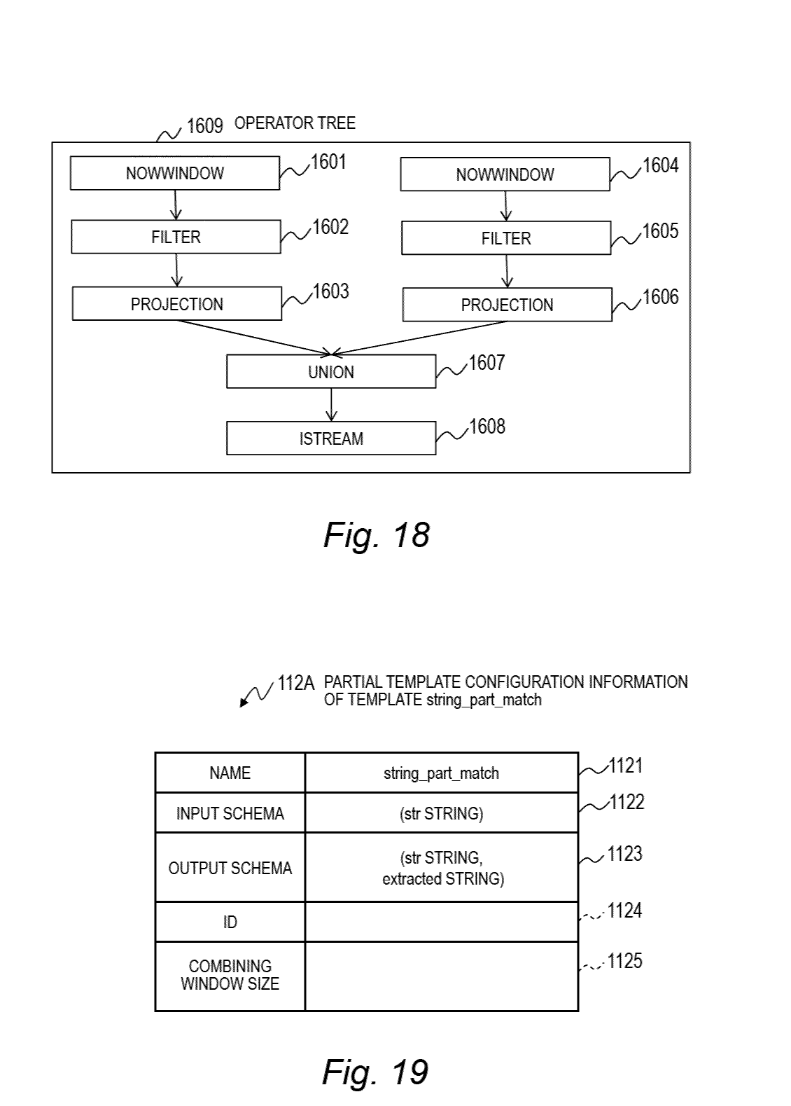

FIG. 18 is a diagram for illustrating an example of the operator tree of the ID-unassigned template 111A which is denoted by 1609. The operator tree 1609 includes processing inputs of two NOWWINDOWs 1601 and 1604 by filters 1602 and 1605, respectively, and combining (UNION 1607) projections (PROJECTIONs) 1603 and 1606 thereof. The result of the union is output as ISTREAM 1608. The parser 1082 generates the operator tree 1609 by analyzing the structure of the read ID-unassigned template 111A.

In Step 2003 of FIG. 22, the automatic ID assigning module 1081 analyzes the operator tree 1609 to determine whether or not the operator tree 1609 includes only stateless relational operation operators (FILTERs, PROJECTIONs, and UNION), stream operations (ISTREAM and the like), and window operations (NOWWINDOW and the like). In other word, the automatic ID assigning module 1081 determines whether or not an ID assigned to data in the template is traceable. The automatic ID assigning module 1081 proceeds to Step 2005 when the ID is traceable, and to Step 2004 when the ID is not traceable. In Step 2004, an error message to the effect that a query for assigning an ID cannot be generated is sent to the terminal 130, and the processing is terminated.

In Step 2005, the automatic ID assigning module 1081 adds an Id column to the SELECT statement of every query definition in the ID-unassigned template 111A to generate the template 111-3. The template 111-3 of FIG. 17 is generated from the ID-unassigned template 111A of FIG. 16 as a result.

In Step 2006, the automatic ID assigning module 1081 generates the template configuration information 112-3 by registering an Id in the field for the ID 1124 of the partial template configuration information 112A.

The automatic ID assigning module 1081 generates the template 111-3 and the template configuration information 112-3 through the processing described above, and then ends the processing.

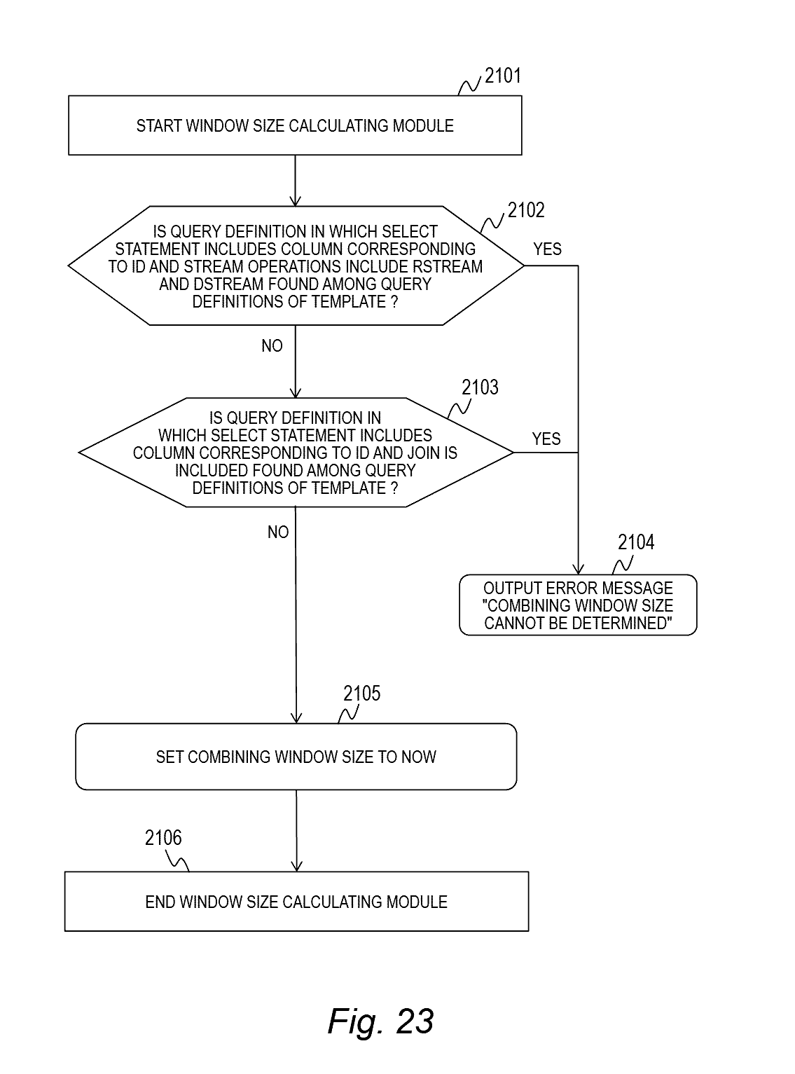

FIG. 23 is a flowchart for illustrating an example of processing that is executed by the window size calculating module 1083. This processing is the one that is executed in Step 1904 of FIG. 21 (2101).

The window size calculating module 1083 determines whether or not a query definition in which the SELECT statement includes a column corresponding to an ID and stream operations include RSTREAM and DSTREAM is found among query definitions of the template 111-3 (2102). In other words, the window size calculating module 1083 removes RSTREAM and DSTREAM, which lead to a delay in output stream data, in order to trace the ID assigned in the template 111-3 accurately. The window size calculating module 1083 proceeds to Step 2104 when the operations of the template 111-3 cause a delay, and to Step 2103 when a delay is not caused.

The window size calculating module 1083 next analyzes the template 111-3 to determine whether or not the template 111-3 has a query definition in which the SELECT statement includes a column corresponding to an ID and JOIN is included (2103). In other words, the window size calculating module 1083 removes a query definition that includes JOIN because a query definition that includes JOIN poses a problem of which ID to select from among a plurality of IDs of pieces of data to be joined. The window size calculating module 1083 proceeds to Step 2104 when a query definition that includes JOIN is found, and otherwise proceeds to Step 2105.

In Step 2105, the window size calculating module 1083 sets the combining window size 1125 in the template configuration information 112-3 to “NOW”.

In Step 2104, the window size calculating module 1083 sends to the terminal 130 an error message to the effect that the window size to be used in the combining cannot be determined, and terminates the processing.

Through the processing described above, the window size in the combining is set to “NOW” when the template 111-3 fulfills a given condition, and the determined window size is set in the template configuration information 112-3 (2106).

As described above, the template 111-3 and the template configuration information 112-3 can be generated automatically from the ID-unassigned template 111A and the partial template configuration information 112A in which the window size is undetermined in the second embodiment and, accordingly, the work of a user or an administrator who operates the terminal 130 can be further reduced.

### Third Embodiment

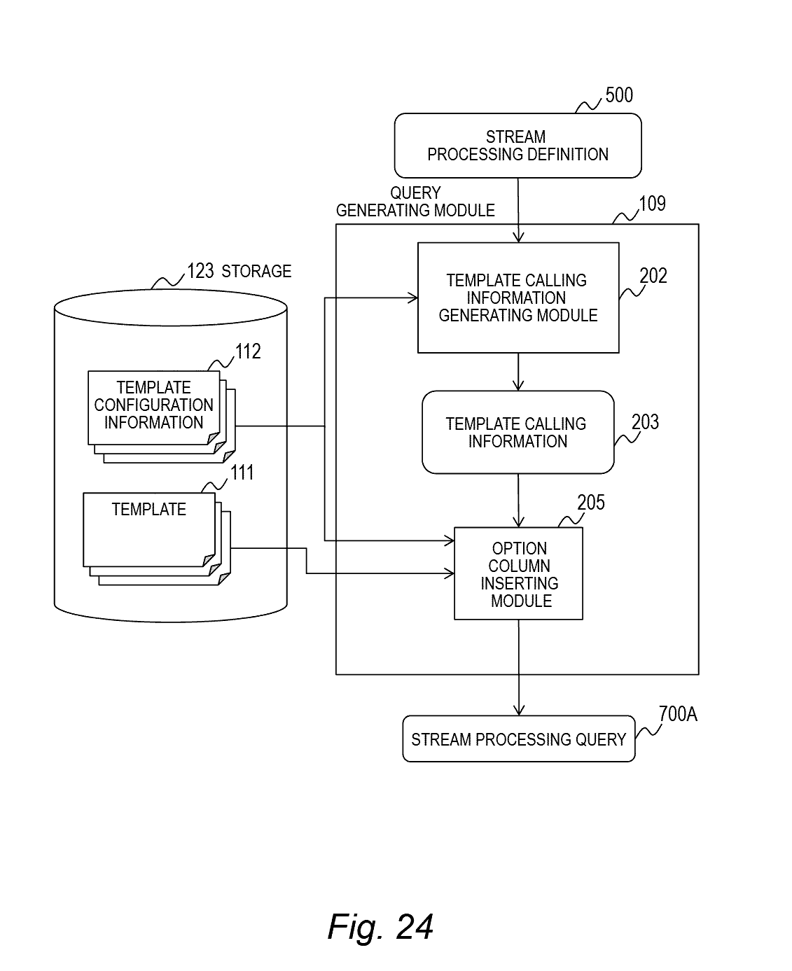

FIG. 24 to FIG. 27 are diagrams for showing an example of input-output relations of the query generating module 109 according to a third embodiment of this invention. In the third embodiment, an option column inserting module 205 is provided in place of the combining processing inserting module 204 described in the first embodiment with reference to FIG. 3. The rest of the configuration of the third embodiment is the same as that of the first embodiment.

The query generating module 109 receives one of the stream processing definitions 500 and uses the template calling information generating module 202 to generate the template calling information 203 in the same manner as in the first embodiment. The query generating module 109 next uses the option column inserting module 205 to define a query for inserting the option column in the result of the processing of the template 111, and generates a stream processing query 700A. In the third embodiment, an ID(=strID) assigned to the essential column and the option column is used to determine a place where the option column is inserted.

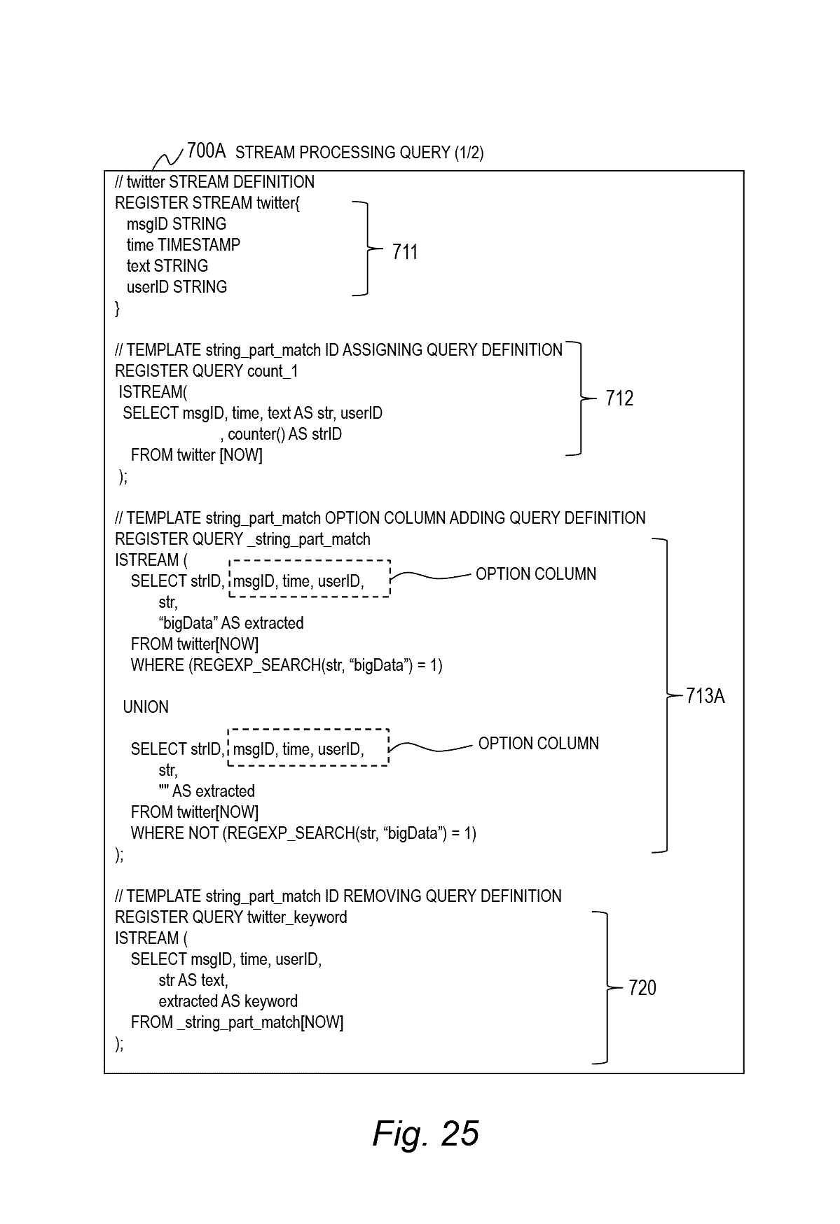

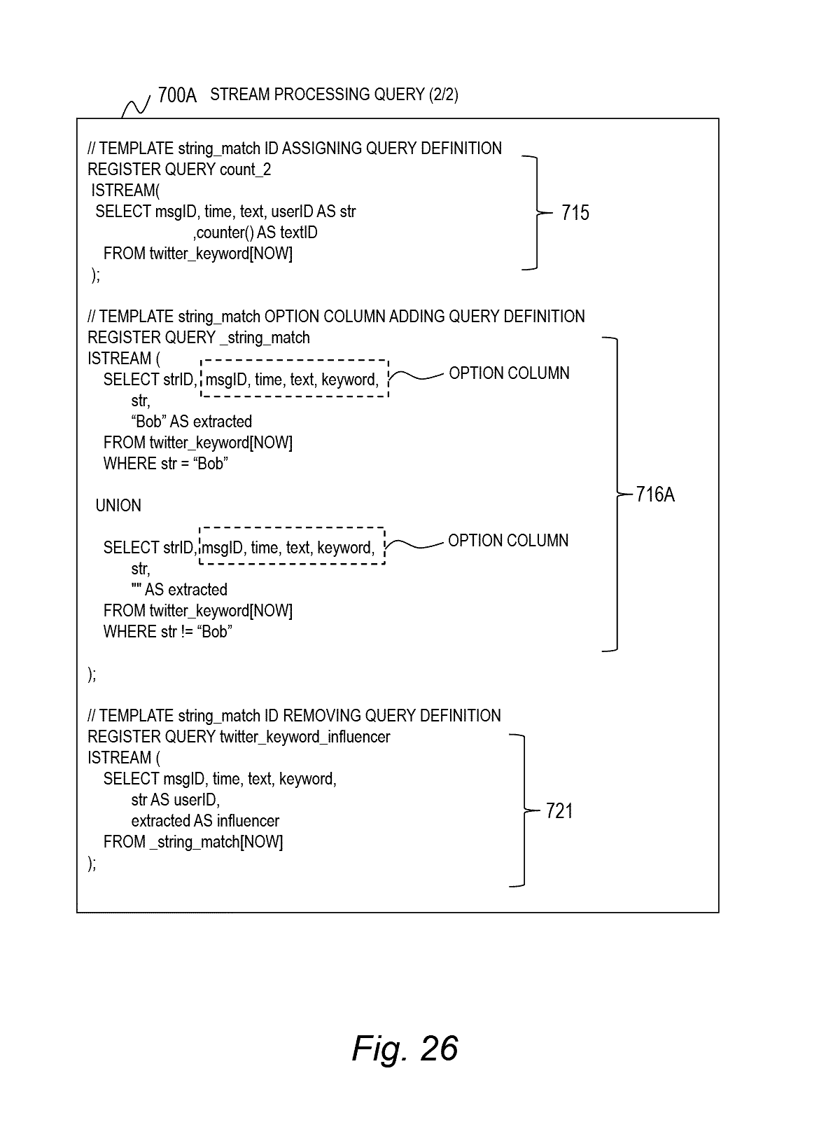

FIG. 25 is the first half of a diagram for showing an example of the stream processing query 700A, which is generated by the query generating module 109. FIG. 26 is the second half of the diagram for showing an example of the stream processing query 700A.

The stream processing query 700A is similar to the stream processing query of FIG. 8 described in the first embodiment in that the name and input schema of stream data processing are defined in 711 of FIG. 25. In 712 of FIG. 25, a query that assigns an ID (strID) to the input data is defined as in FIG. 8 described in the first embodiment.

In 713A of FIG. 25, the specifics of “string_part_match” of the template 111-1 are deployed in the stream processing query 700A as in the first embodiment, and the option column inserting module 205 inserts the columns “msgID”, “time”, and “userID”, which constitute the option column whose ID matches the assigned ID (strID). Once the option column that has a matching strID is inserted to the processing result of the template 111-1, the strID itself is no longer needed, and the query generating module 109 defines a query for removing the strID (720).

The template 111-2 of FIG. 26 which is a template “string_match” is processed in a similar manner, and an ID is assigned to the input schema in 715 of FIG. 26. In 716A of FIG. 26, the specifics of “string_{—} match” of the template 111-2 are deployed in the stream processing query 700A as in the first embodiment, and the option column inserting module 205 inserts the columns “msgID”, “time”, “text”, and “keyword”, which constitute the option column whose ID matches the assigned ID (strID). Once the option column that has a matching ID is inserted, the ID itself is no longer needed, and the query generating module 109 defines a query for removing the strID (721).

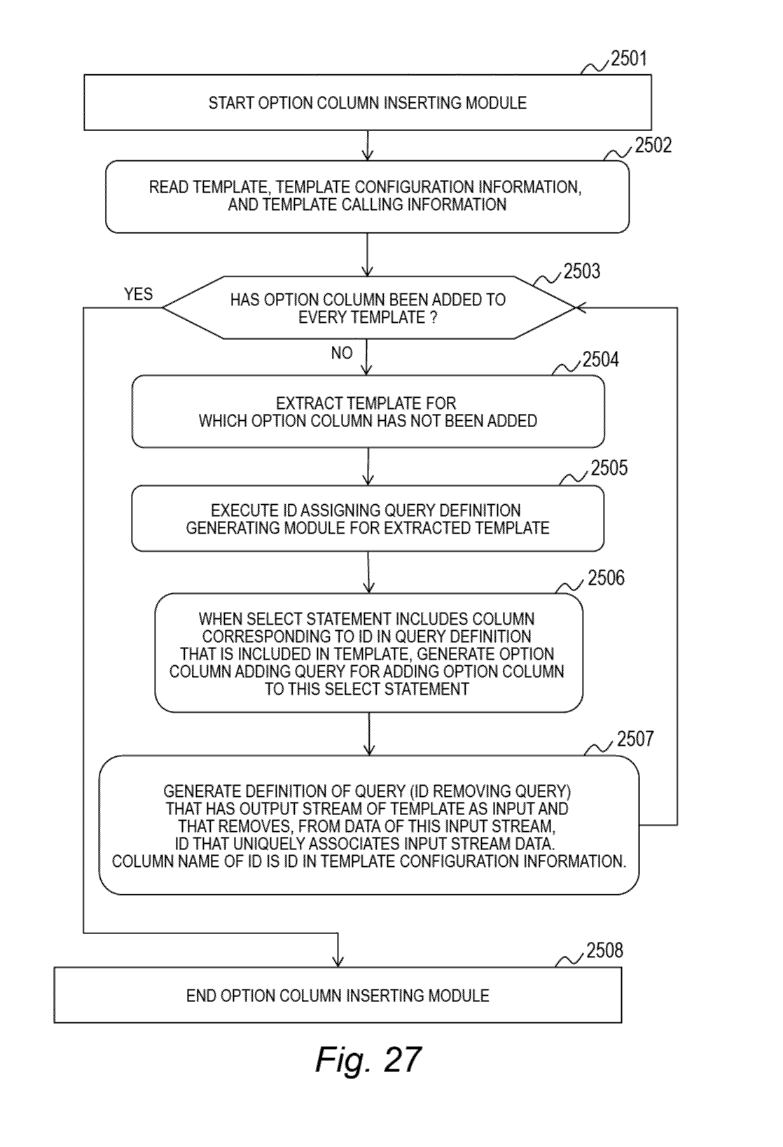

FIG. 27 is a flowchart for illustrating an example of processing that is executed by the option column inserting module 205 of the query generating module 109. This processing is executed after the processing of the template calling information generating module 202 of FIG. 3 (FIG. 24) is completed.

The option column inserting module 205 first reads the stream processing definition 500, the template configuration information 112, and the template calling information 203 (2501 and 2502). The option column inserting module 205 determines whether or not the option column has been added to every template 111 written in the stream processing definition 500 (2503). The option column inserting module 205 ends the processing of FIG. 27 in the case where the addition has been completed for every written template 111 (2508). In the case where the addition has not been completed for some of the written templates 111, on the other hand, the option column inserting module 205 repeatedly executes Steps 2504 to 2507 until every written template 111 has been processed.

The option column inserting module 205 extracts the template 111 to which the option column has not been added (2504). The option column inserting module 205 executes the ID assigning query definition generating processing (ID assigning query definition generating module) described in the first embodiment with reference to FIG. 12 for the extracted template 111 (2505).

The option column inserting module 205 next executes the in-template query definition generating processing described in the first embodiment with reference to FIG. 13 and, in the case where the SELECT statement includes a column corresponding to an ID in a query definition that is included in the template 111, generates a query for adding the option column to this SELECT statement (2506).

The option column inserting module 205 next generates the definition of a query that has output stream data of the template 111 as an input and that removes, from the input stream data, an ID that is uniquely associated with the input stream data (an ID removing query). The column name of the ID is the ID in the template configuration information 112.

Through the processing described above, output stream data can be obtained in which the option column has been added to the essential column processed by the template 111.

### Fourth Embodiment

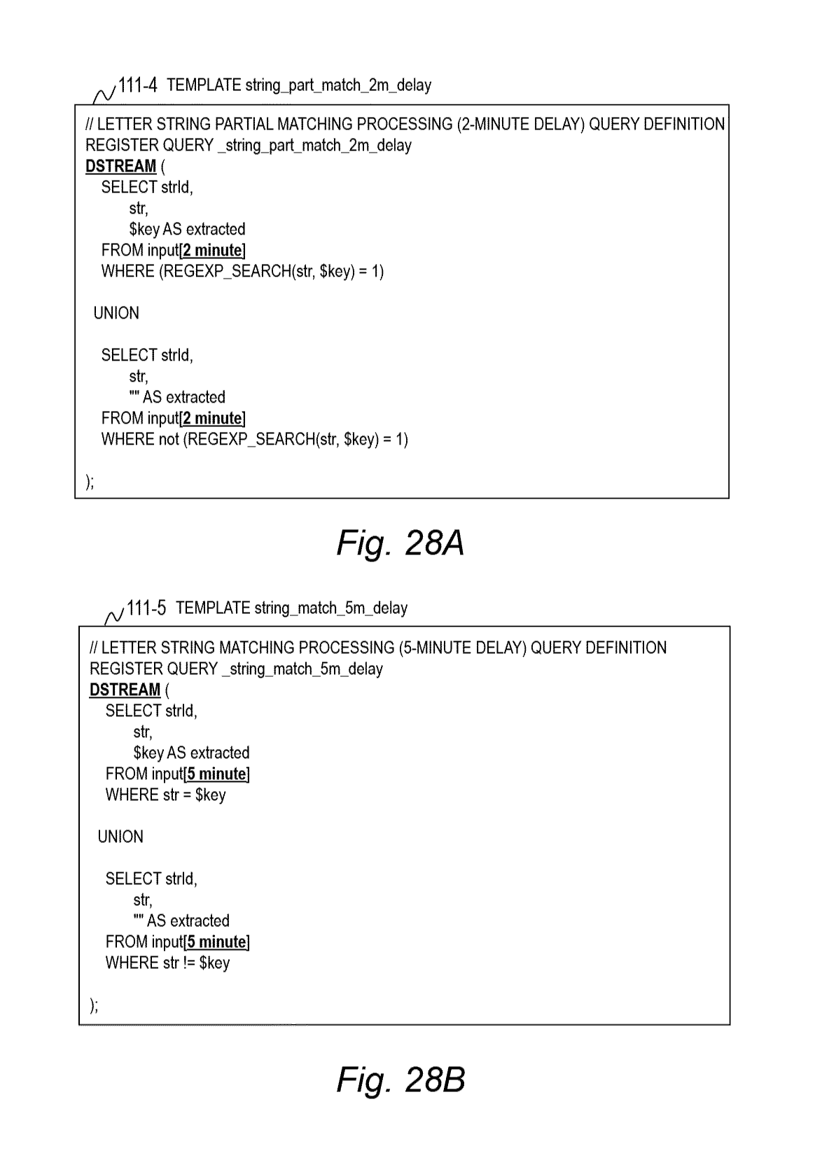

FIG. 28A and FIG. 28B to FIG. 33 are diagrams of a fourth embodiment of this invention. While the window size in the combining is “NOW” in the first embodiment to the third embodiment, the window size 1125 in the fourth embodiment is set to two minutes for “string_part_match” in a template 111-4, and to five minutes for “string_match” in a template 111-5. The rest of the configuration of the fourth embodiment is the same as that of the first embodiment.

In the fourth embodiment, the query generating module 109 can generate the definition of a query for keeping the option column for the duration of a given time window by taking into account a delay due to the processing of the template 111, and for sequentially combining output stream data that has undergone the processing of the template 111 with the option column.

FIG. 28A is a diagram for showing an example of the template 111-4, which is a template “string_part_match_{—}2m_delay”. In FIG. 28A, a difference from the template “string_part_match” described in the first embodiment with reference to FIG. 4A is indicated by bold-face letters. The template 111-4, which is a template “string_part_match_{—}2m_delay”, differs from FIG. 4A of the first embodiment in that a window size of two minutes is set for DSTREAM.

FIG. 28B is a diagram for showing an example of the template 111-5, which is a template “string_match_{—}5m_delay”. In FIG. 28B, a difference from the template “string_match” described in the first embodiment with reference to FIG. 4B is indicated by bold-face letters. The template 111-5, which is a template “string_match_{—}5m_delay”, differs from FIG. 4B of the first embodiment in that a window size of five minutes is set for DSTREAM.

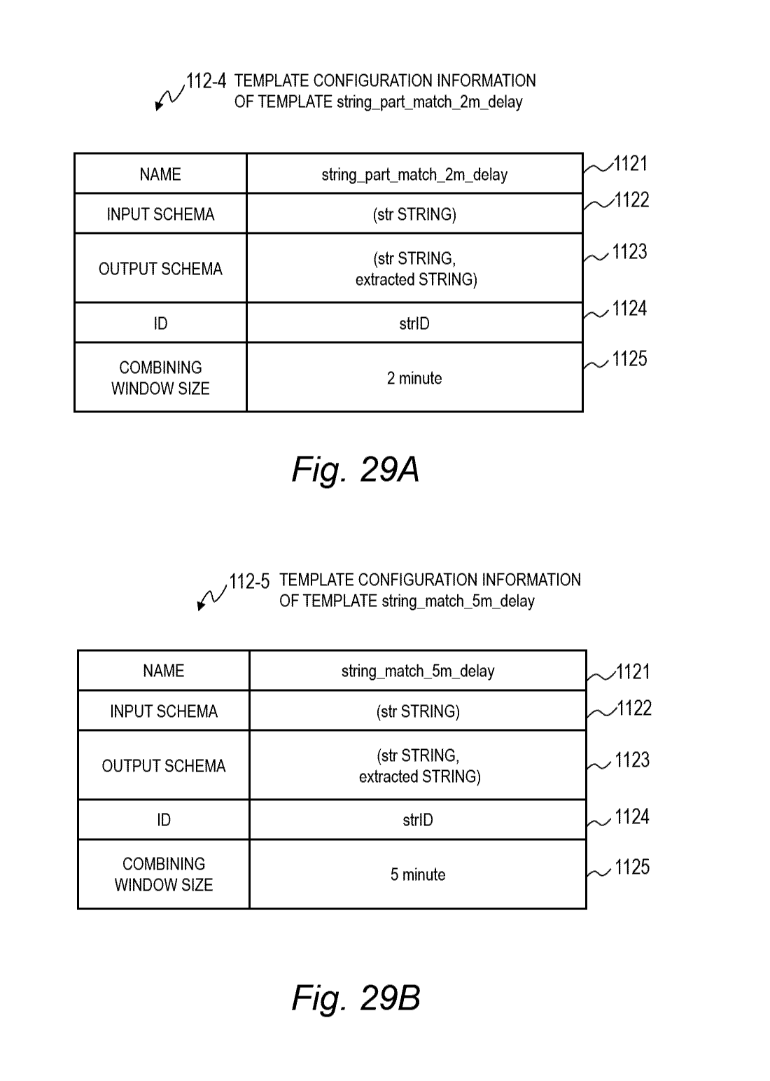

FIG. 29A is a diagram for showing an example of template configuration information 112-4 of the template 111-4, which is a template “string_part_match_{—}2m_delay”. The template configuration information 112-4 differs from the configuration information of the template “string_part_match” which has been described in the first embodiment with reference to FIG. 5A in that the name 1121 is “string_part_match_{—}2m_delay”, and in that the combining window size 1125 is “two minutes”.

FIG. 29B is a diagram for showing an example of template configuration information 112-5 of the template 111-5, which is a template “string_match_{—}5m_delay”. The template configuration information 112-5 differs from the configuration information of the template “string_match” which has been described in the first embodiment with reference to FIG. 5B in that the name 1121 is “string_match_{—}5m_delay”, and in that the combining window size 1125 is “five minutes”.

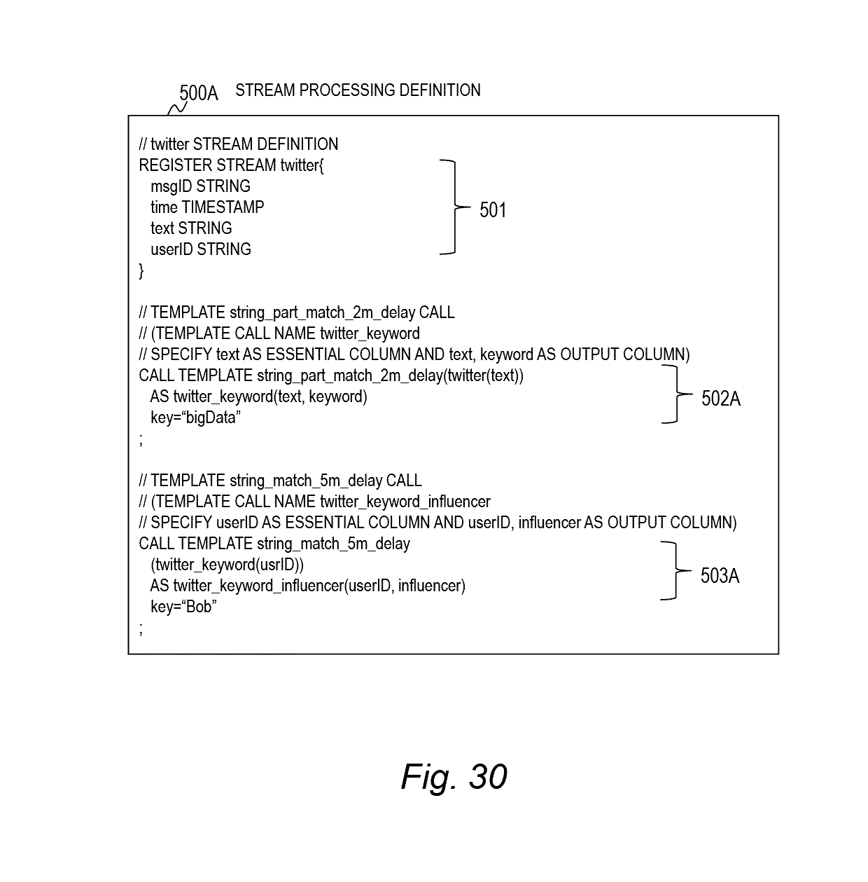

FIG. 30 is a diagram for showing an example of the stream processing definitions 500A. The stream processing definition 500A differs from the stream processing definition 500 described in the first embodiment with reference to FIG. 6 in that the name of the template 111 in 502A of FIG. 30 and the name of the template 111 in 503A of FIG. 30 are “string_part_match_{—}2m_delay” and “string_match_{—}5m_delay”, respectively. The rest of FIG. 30 is the same as FIG. 6.

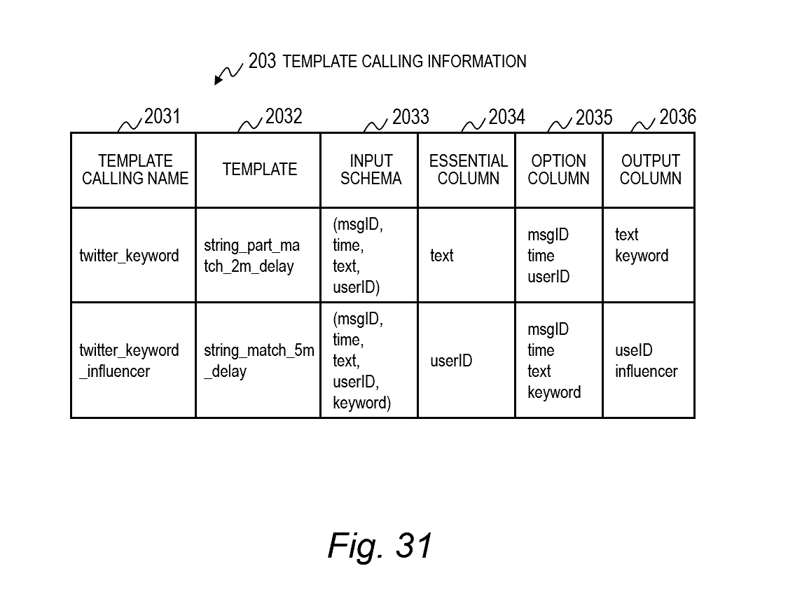

FIG. 31 is a diagram for showing an example of the template calling information 203 generated by the query generating module 109. The template calling information 203 of FIG. 31 differs from the template calling information 203 described in the first embodiment with reference to FIG. 7 in that names stored as the template 2032 are changed in the manner described with reference to FIG. 30. The rest of the template calling information 203 of this embodiment is the same as in the first embodiment.

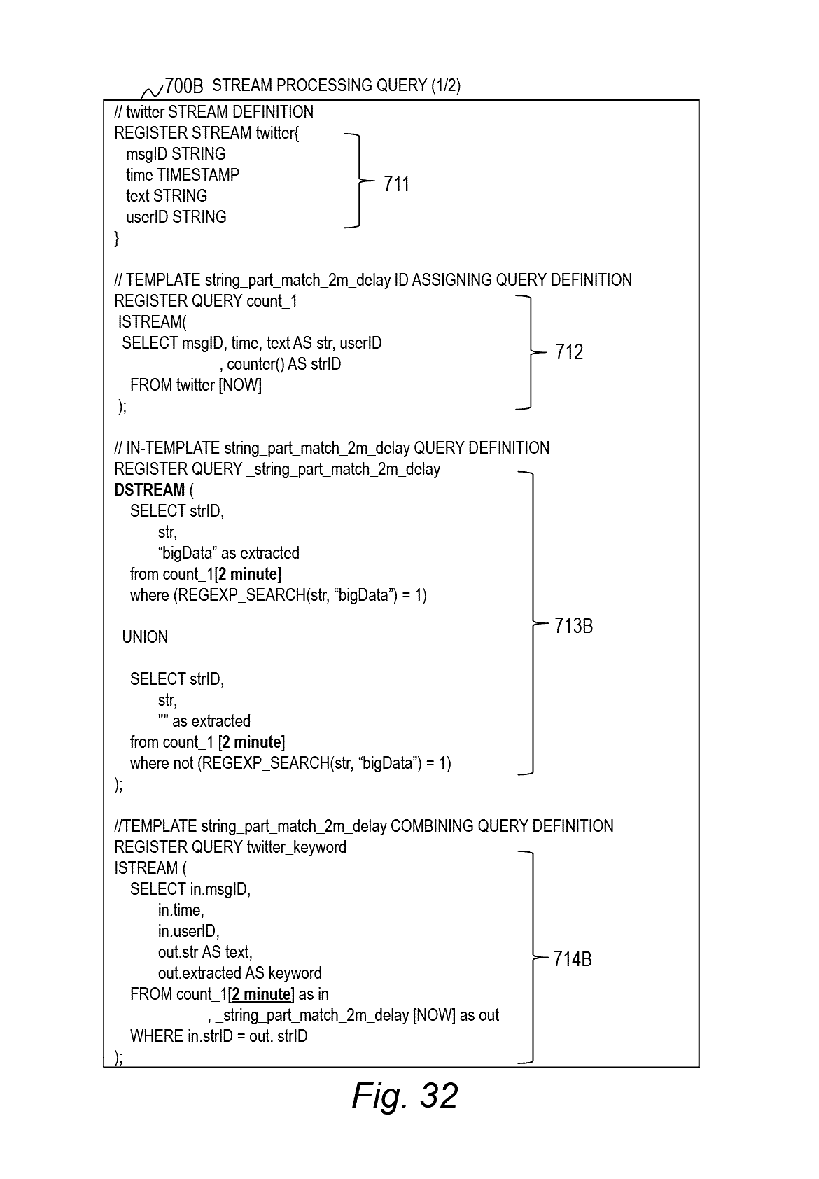

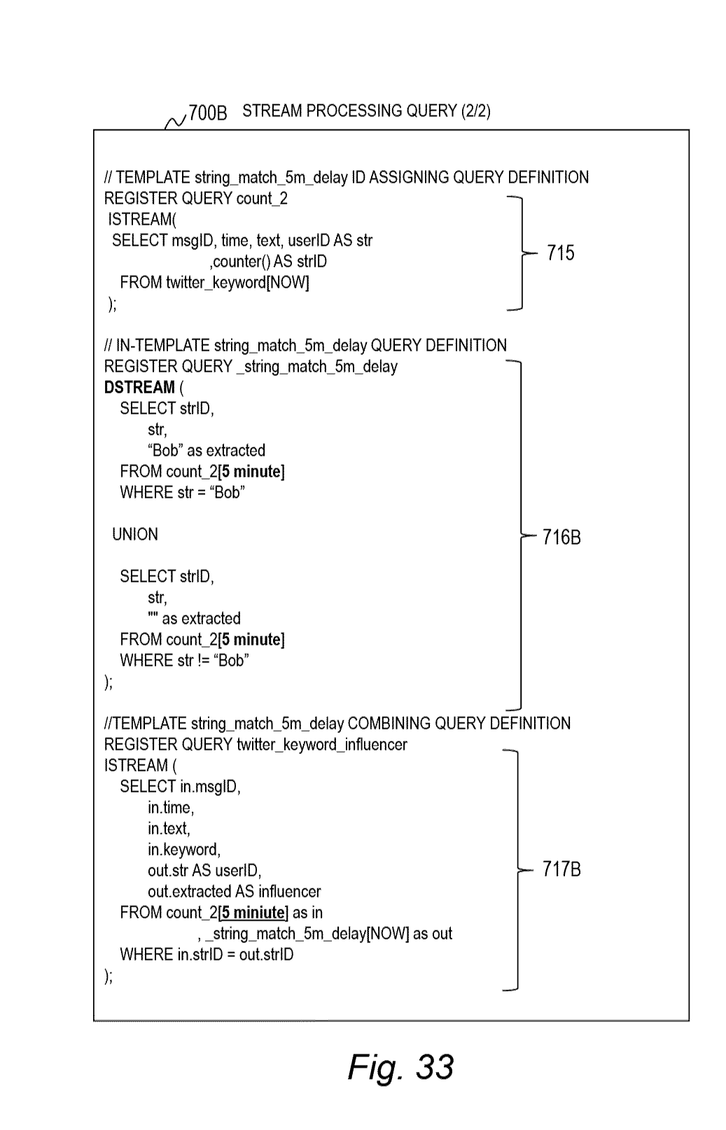

In this embodiment, the query generating module 109 executes the functions and processing described in the first embodiment with reference to FIG. 3 and FIG. 10 to FIG. 14 to generate a stream processing query 700B, which is shown in FIG. 32 and FIG. 33.

FIG. 32 and FIG. 33 are the first half and second half of a diagram for showing an example of the stream processing query 700B, which is generated based on the stream processing definition 500A, the templates 111, and the template configuration information 112.

In FIG. 32 and FIG. 33, differences of the stream processing query 700B from the stream processing query 700 described in the first embodiment with reference to FIG. 8 and FIG. 9 are expressed in bold-face letters. Firstly, stream data processing and the window size are changed to DSTREAM and two minutes, respectively, in a query definition 713B of FIG. 32, and the window size is changed to two minutes in a combining query definition 714B of FIG. 32.

Similarly, stream data processing and the window size are changed to DSTREAM and five minutes, respectively, in a query definition 716B of FIG. 33, and the window size is changed to five minutes in a combining query definition 717B of FIG. 33.

The stream processing query 700B described above combines the output stream and option column of the processing of the template 111-4, which is a template “string_part_match_{—}2m_delay”, in a two-minute window, combines the output stream and option column of the processing of the template 111-5, which is a template “string_match_{—}5m_delay”, in a five-minute window, and outputs the resultant output streams.

Through the processing described above, a time required for processing in each template 111 is taken into account so that a delay in output stream can be tolerated.

The computers, processing units, and processing means described related to this invention may be, for a part or all of them, implemented by dedicated hardware.

The variety of software exemplified in the embodiments can be stored in various media (for example, non-transitory storage media), such as electro-magnetic media, electronic media, and optical media and can be downloaded to a computer through communication network such as the Internet.

This invention is not limited to the foregoing embodiments but includes various modifications. For example, the foregoing embodiments have been provided to explain this invention to be easily understood; they are not limited to the configurations including all the described elements.

What is claimed is:

1. A query generating method for generating a query for processing input stream data, the query generating method being performed by a computer comprising a processor and a memory,
the query generating method comprising:
a first step of reading, by the computer, a template in which the input stream data is divided into an essential column and an option column, and processing to be executed for the essential column is defined; and
a second step of generating, by the computer, a query for dividing the input stream data into the essential column and the option column, for processing the essential column by using the template, and for outputting a result of the processing of the template and the option column as one piece of data.

2. The query generating method according to claim 1,
wherein, in the first step, the template comprises a definition for associating the essential column and the option column into which the input stream data is divided with each other via an identifier, and
wherein the second step comprises:
generating a query for assigning the essential column and the option column the identifier that associates the essential column and the option column into which the input stream data is divided with each other;
generating a query for processing the essential column by using the template; and
generating a query for combining a result of the processing of the template and the option column that are associated with the identifier, and outputting the combined processing result and option column as one piece of data.

3. The query generating method according to claim 1, wherein the second step comprises:
generating a query for dividing the input stream data into the essential column and the option column;
generating a query for processing the essential column by using the template; and
generating a query for keeping the option column for duration of a given time window (a window size) which is determined by how much delay is caused by the processing of the template, and for outputting a result of the processing of the template and the option column as one piece of data.

4. The query generating method according to claim 1, wherein the second step comprises:
generating a query for assigning the essential column and the option column an identifier that associates the essential column and the option column into which the input stream data is divided with each other; and
generating a query for inserting, when the essential column is processed by the query included in the template, an option column having an identifier associated with the essential column into a result of the processing of the query, and for outputting this processing result and the option column as one piece of data.

5. The query generating method according to claim 1, wherein the second step comprises:
adding a query for assigning the essential column and the option column an identifier that associates the essential column and the option column into which the input stream data is divided with each other;
generating a query for processing the essential column by using the template; and
generating a query for outputting a result of the processing of the template and the option column that are associated with the identifier as one piece of data.

6. The query generating method according to claim 3, wherein the second step further comprises determining the window size by analyzing the template.

7. A query generating device configured to generate a query for processing input stream data, comprising:
a processor;
a memory; and
a query generating module configured to:
read a template in which the input stream data is divided into an essential column and an option column, and processing to be executed for the essential column is defined; and
generate a query for dividing the input stream data into the essential column and the option column, for processing the essential column by using the template, and for outputting a result of the processing of the template and the option column as one piece of data.

8. The query generating device according to claim 7,
wherein, the template comprises a definition for associating the essential column and the option column into which the input stream data is divided with each other via an identifier, and
wherein the query generating module comprises:
an ID assigning module configured to generate a query for assigning the essential column and the option column the identifier that associates the essential column and the option column into which the input stream data is divided with each other;
an in-template query generating module configured to generate a query for processing the essential column by using the template; and
a combining query generating module configured to generate a query for combining a result of the processing of the template and the option column that are associated with the identifier, and outputting the combined processing result and option column as one piece of data.

9. The query generating device according to claim 7, wherein the query generating module comprises:
an in-template query generating module configured to generate a query for dividing the input stream data into an essential column and an option column and generate a query for processing the essential column by using the template; and
a combining query generating module configured to generate a query for keeping the option column for duration of a given time window (a window size) which is determined by how much delay is caused by the processing of the template, and for outputting a result of the processing of the template and the option column as one piece of data.

10. The query generating device according to claim 7,
wherein the query generating module comprises an ID assigning module configured to generate a query for assigning the essential column and the option column an identifier that associates the essential column and the option column into which the input stream data is divided with each other, and
wherein the query generating module is further configured to generate a query for inserting, when the essential column is processed by the query included in the template, an option column having an identifier associated with the essential column into a result of the processing of the query, and for outputting this processing result and the option column as one piece of data.

11. The query generating device according to claim 7, wherein the query generating module comprises:
an automatic ID assigning module configured to add a query for assigning the essential column and the option column an identifier that associates the essential column and the option column into which the input stream data is divided with each other;
an in-template query generating module configured to generate a query for processing the essential column by using the template; and
a combining query generating module configured to generate a query for outputting a result of the processing of the template and the option column that are associated with the identifier as one piece of data.

12. The query generating device according to claim 9, wherein the query generating module further comprises a window size calculating module for determining the window size by analyzing the template.
